(19) United States
(12) Patent Application Publication
(10) Pub. No.: US 2016/0212012 A1
(43) Pub. Date: Jul. 21, 2016

(54) SYSTEM AND METHOD OF NETWORK FUNCTIONS VIRTUALIZATION OF NETWORK SERVICES WITHIN AND ACROSS CLOUDS

(71) Applicant: CLEARPATH NETWORKS, INC., Ei Segundo, CA (US)

(72) Inventors: Clifford H. Young, Rancho Palos Verdes, CA (US); Peter Lee, Los Angeles, CA (US)

(21) Appl. No.: 14/914,781

(22) PCT Filed: Aug. 29, 2014
(86) PCT No.: PCT/US14/53602

§ 371 Date: Feb. 26, 2016

Related U.S. Application Data
(60) Provisional application No. 61/872,586, filed on Aug. 30, 2013.

(51) Int. Cl. H04L 12/24; H04L 12/26; H04L 29/08

(52) U.S. Cl. CPC H04L 41/0816; H04L 67/16; H04L 43/16

(57) ABSTRACT

An information technology (IT) services management system comprising instructions that cause the at least one processor to execute a controller. The controller may be programmed to communicate with at least one virtual service container, wherein the controller is further programmed to instantiate a virtual service container at a service hub. Instantiating the virtual service container may comprise sending to a service hub an instruction to instantiate a virtual service container; receiving an indication of a secure connection between the controller and the virtual service container; receiving from the virtual service container a request for a virtual service container configuration; verifying an identity of the virtual service container; and providing the virtual service container with a virtual service container configuration, wherein the virtual service container configuration indicates at least one Virtual network service to be provided to a managed component by the virtual service container.

### PRIORITY

This application claims the benefit of U.S. Provisional Application Ser. No. 61/827,586 filed on Aug. 30, 2013, which is incorporated herein by reference in its entirety.

### BACKGROUND

This application discloses an invention that is related, generally and in various embodiments, to systems and methods for managing a network.

Information technology (IT) services or network functions allow enterprise customers to install, connect, manage and secure their network environment. Traditional systems for providing network functions, however, involve dedicated hardware present on the customer's premises, that is, customer premises equipment (CPE). IT services or network functions are provisioned and managed by configuring the CPE equipment either locally or remotely. The CPE equipment model, however, includes several inherent liabilities. For example, integration of that CPE into the customer's network is required. Changes to network functions are made by changing the configuration of the CPE equipment at the customer's premises. These changes often require maintenance windows and downtime. Installation & maintenance requires either dedicated IT staff at the customer's premises or a complicated remote provisioning set-up and set-up. Furthermore, increasingly more of the users need to access network resources from outside of the corporate firewall where the CPE device has additional limitations. Also, for example, the processing capacity and application availability to provide network functions is fixed based on the hardware that is actually present at the customer's premises.

### DRAWINGS

Various example embodiments are described herein by way of example in conjunction with the following figures, wherein:

FIG. 1 is a block diagram showing one embodiment of an environment for managing a network.

FIG. 2 is a block diagram showing one embodiment of an environment for routing network traffic from a managed Local Area Network (LAN) to a virtual service container executed at a service hub.

FIG. 3 is a block diagram showing another embodiment of a network configuration for routing network traffic from a LAN to a virtual service container executed at a service hub.

FIG. 4 is a block diagram showing yet another embodiment of a network configuration for routing network traffic from a LAN to a virtual service container executed at a service hub.

FIG. 5 is a block diagram showing one embodiment of a network configuration for routing network traffic from a user device to a virtual service container executed at a service hub.

FIG. 6 is a block diagram showing one embodiment of a network services management system.

FIG. 7 is a diagram showing one embodiment of an environment for implementing the system comprising multiple distributed services hubs.

FIG. 8 is a system diagram showing one embodiment of a virtual service container.

FIG. 9 is a block diagram of a virtual network services device showing various example modules.

FIG. 10 is a block diagram showing one example embodiment of an implementation of the controller of FIG. 1.

FIG. 11 is a block diagram showing one embodiment of the activation server of FIG. 10.

FIG. 12 is a block diagram showing one embodiment of the logger server of FIG. 10.

FIG. 13 illustrates various embodiments of the manager server.

FIG. 14 illustrates various embodiments of the web-based management portal.

FIG. 15 is a flow chart showing one embodiment of a process flow that may be executed by the controller to instantiate and configure an instance of a virtual service container.

FIG. 16 is a flow chart illustrating one embodiment of a process flow for downloading and configuring a service module of a virtual service container.

FIG. 17 is a flow chart illustrating one embodiment of a process flow for modifying the configuration of a virtual service container.

FIG. 18 is a diagram showing one embodiment of a set of network services that may be implemented by service modules executed by virtual service containers as described herein.

FIG. 19 is a flow chart showing one embodiment of a process flow that may be executed by various components of the environment of FIG. 1 to dynamically modify virtual network services provided to one or more managed devices.

FIG. 20 is a flow chart showing one embodiment of a process flow for actively managing the virtual network service load of a managed component.

FIG. 21 is a diagram showing one embodiment of an environment for providing virtual network services to customers utilizing virtual service containers.

FIG. 22 is a system diagram showing one embodiment of a controller and virtual service container including details of the controller.

FIG. 22A is a system diagram showing another embodiment of a controller.

FIG. 23 is a diagram of an environment that shows multi-tenancy in a virtual service container such that a single virtual service container is able to deliver multiple services of the same type via a separate interface created by a virtual network splitter.

FIG. 24 is a diagram of an environment utilizing additional layers of multi-tenancy.

FIG. 25 is a diagram of a service hub illustrating layered service modules.

### DESCRIPTION

Various embodiments are directed to systems and methods for providing virtual network functions to a managed component (e.g., from a remote processing location). The managed component may be a computer device, group of computer devices, network, or networks.

It is to be understood that the figures and descriptions of the disclosed invention have been simplified to illustrate elements that are relevant for a clear understanding of the invention, while eliminating, for purposes of clarity, other elements. Those of ordinary skill in the art will recognize, however, that these and other elements may be desirable. However, because such elements are well known in the art, and because they do not facilitate a better understanding of the invention, a discussion of such elements is not provided herein.

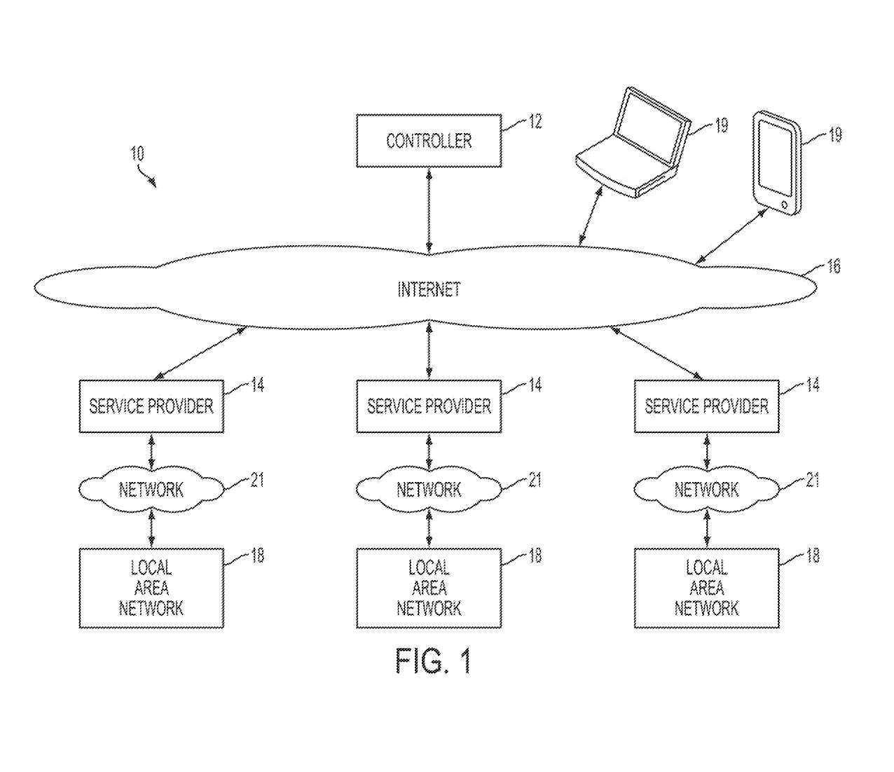

FIG. 1 is a block diagram showing one embodiment of an environment 10 for managing a network. The environment 10 may be utilized to provide a company with virtual network functions for installing, connecting, managing and securing their network environment without having to rely on several discrete systems. According to various embodiments, the environment 10 includes a controller 12 and at least one IT service provider 14. The service providers 14 may be physical devices present at the customer's premises (customer premises equipment or CPE) or may be virtual service containers executed at a service hub either at or remote from the customer's premises. The IT service providers 14 may be in communication with the controller 12 via any suitable type of network, such as the Internet 16 as shown in FIG. 1. In other embodiments, described herein, the controller 12 is in communication with the various service providers 14 via the Internet 16, as shown in FIG. 1. Also, in some embodiments, the controller 12 and one or more of the service providers may be executed at a common location. Although only three service providers 14 are shown in FIG. 1, the environment 10 may include any number of service providers 14 in communication with the controller 12.

Service providers 14 may be configured to provide network functions or IT services to managed components, such as one or more managed user devices 19 and/or managed local area networks (LAN's) 18. Each LAN 18 and/or user device 19 is in communication with an associated service provider 14 via a network. For example, a LAN 18 may be in communication with the service provider 14 via a network 21 that may include any suitable type of network or network component including, for example, an intermediate local area network, all or a portion of the network of an Internet Service Provider (ISP), the Internet 16, etc. User devices 19, as described herein, may be in communication with an associated service provider 14 via the Internet 16 and/or any other suitable type of network.

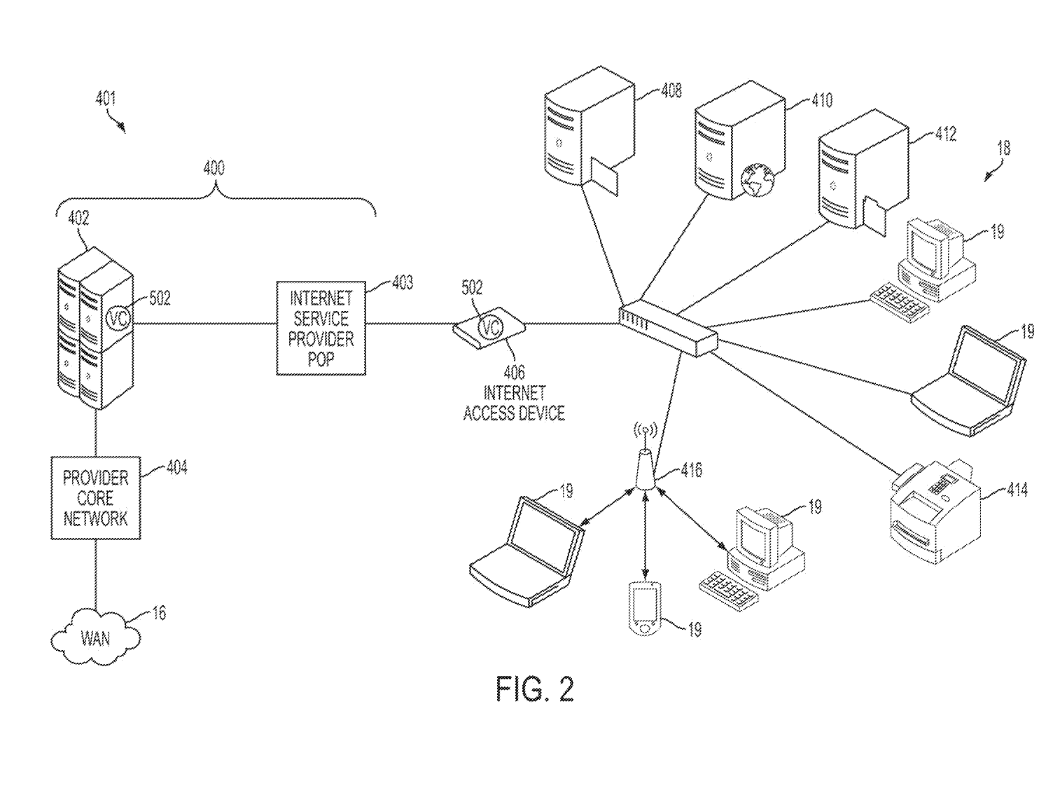

To provide network functions to the LAN's 18 and/or user devices 19, it is desirable that the service providers 14 be positioned to intercept and process network traffic directed to or from the managed components (e.g., managed devices and/or managed networks). Service providers 14 that are positioned to intercept network traffic directed to or from managed components may be referred to as being in the gateway position. FIG. 2 is a block diagram showing one embodiment of a network configuration 401 for routing network traffic from a managed LAN 18 to a virtual service container 502 executed at a service hub 402. In the example embodiment shown in FIG. 2, the LAN 18 comprises various computing equipment and functionalities. For example, the LAN 18 comprises various servers for providing services to the LAN 18. The servers may include, for example, one or more e-mail servers 408, one or more web servers 410, one or more file servers 412, etc. One or more printers 414 may also be present on the LAN 18 along with various user devices 19. Various components of the LAN 18 may be in communication with one another via one or more Ethernet switches 418. Although only one Ethernet switch 418 is shown in FIG. 2, it will be appreciated that multiple Ethernet switches may be utilized in any suitable configuration. In some embodiments, the LAN 18 may also comprise one or more wireless access points 416, which may be configured according to an IEEE 802.11x standard or any other suitable standard or standards. Various user devices 19 and/or other network components may take part in the LAN 18 via the one or more wireless access points 416.

An edge network device 406 may route traffic to and from the various components of the LAN 18. In some embodiments, the edge network device 406 may be an Internet access device 406 in communication with an Internet service provider network 400 as shown. Communications between the LAN 18 and the Internet 16 may be routed through the Internet access device 406 and service provider network 400. For example, the Internet access device 406 may be in communication with a service provider point-of-presence or POP 403. The POP 403 may route network traffic to and from the LAN 18 to the Internet 16 via various core network components of the provider, referred to as the provider core network 404. A service hub 402 may be positioned logically between the POP 403 and the core network 404. The service hub 402 may comprise one or more servers for executing one or more virtual service containers 502 and/or controllers 12. Because the service hub 402 is logically positioned between the POP 403 and the core network 404 it may have the capability to intercept incoming and outgoing traffic of the LAN 18. In other words, virtual service containers 502 executed at the service hub 402 may be at a gateway position relative to the managed network (e.g., LAN 18). In some embodiments, the edge network device 406, or another consumer premises device in the gateway position for the LAN 18, may execute a virtual service container 502 and virtual network functions to the LAN 18 and/or components thereof. For example, some network functions may be provided by service providers at the geographic locus of the LAN 18 while other virtual network functions may be provided remotely by service providers (e.g., virtual service containers 502) as described herein.

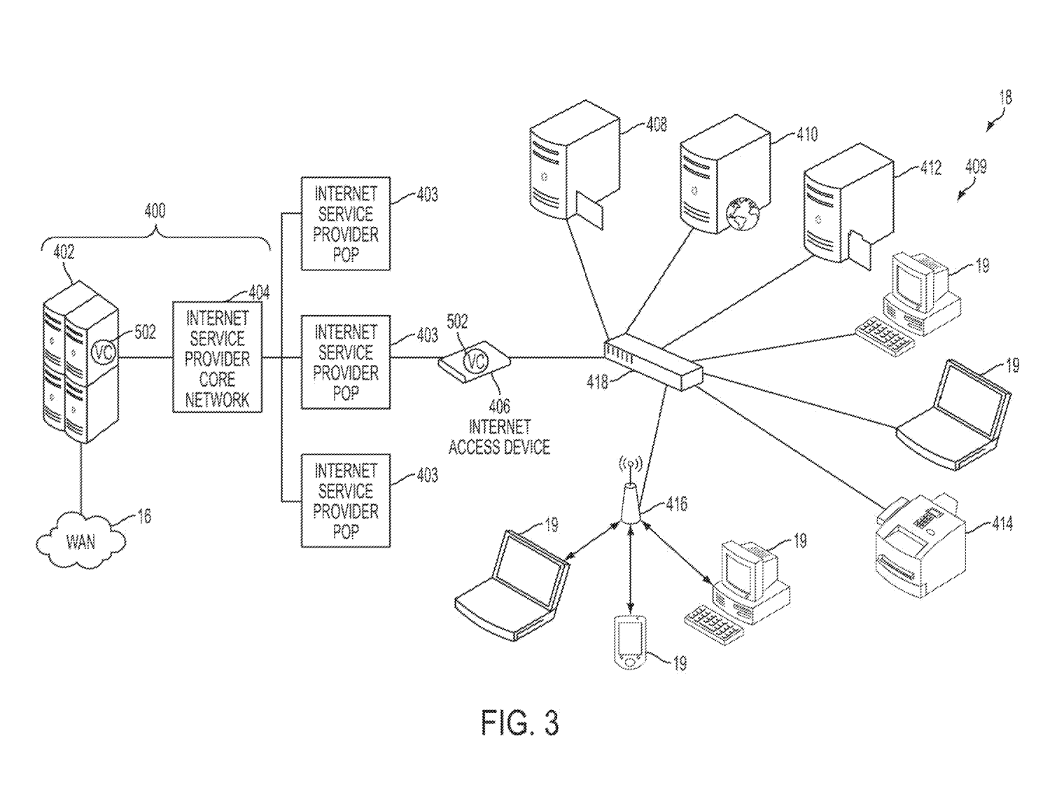

FIG. 3 is a block diagram showing another embodiment of a network configuration 409 for routing network traffic from a LAN 18 to a virtual service container 502 executed at a service hub 402. In the configuration 409, the Internet access device 406 is in communication with a POP 403 of the service provider network 400. Additional POP's 403 are shown and may be in communication with other LAN's 18 and/or devices 19. In FIG. 3, the service hub 402 is positioned between the provider core network 404 and the Internet 16. Accordingly, in the example embodiment shown in FIG. 3, the provider core network 404 comprises functionality for distinguishing network traffic originating from the LAN 18 and directing it to the appropriate service providers 14 executed by the service hub 402. For example, the provider core network 404 may be configured to discriminate between network traffic to or from the LAN 18 and network traffic to or from other LAN's 18 or user devices 19. Accordingly, a virtual service container 502 executed at the service hub 402 may be logically positioned at a gateway position for the LAN 18. In some embodiments, the provider core network 404 may also be able to discriminate between different types of network traffic emanating to or from a particular LAN 18. For example, traffic associated with a first user may be directed to a first service provider 14, while traffic associated with a second user may be directed to a different service provider 14 or no service provider at all. In this manner, different levels of service may be provided to different users.

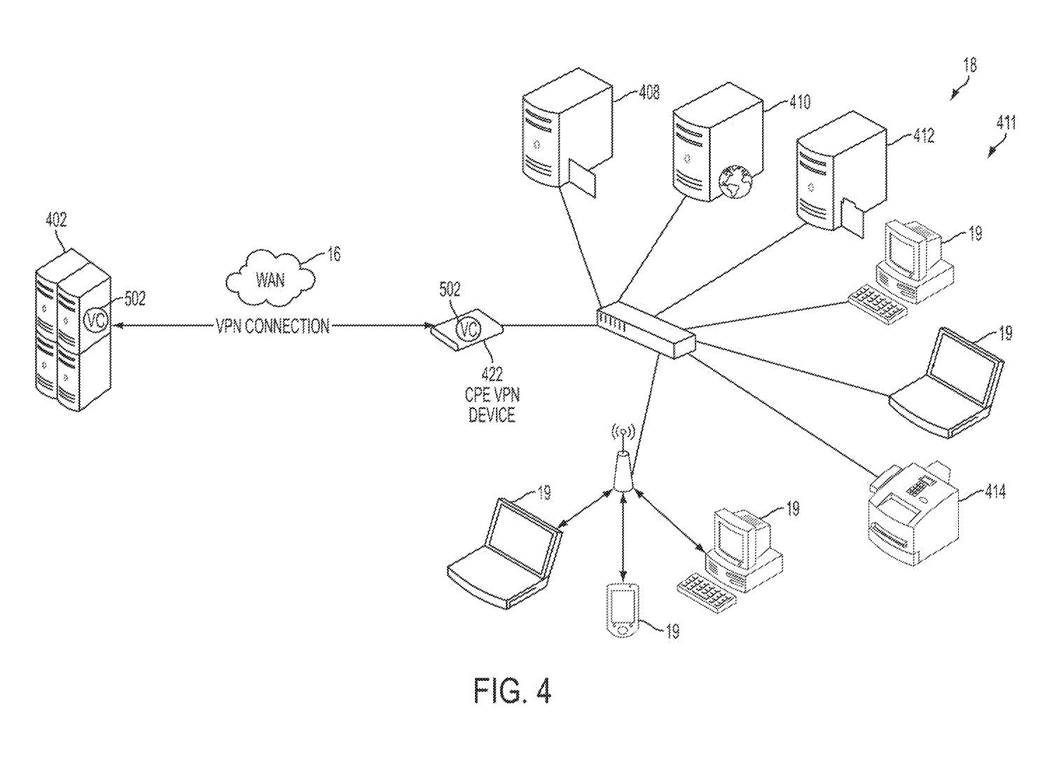

FIG. 4 is a block diagram showing yet another embodiment of a network configuration 411 for routing network traffic from a LAN 18 to a virtual service container 502 executed at a service hub 402. In the configuration 411, the LAN 18 comprises a virtual private network (VPN) device 422. The VPN device 422 may be physically positioned at a geographic locus of the network 18 and, therefore, may be referred to as consumer premises equipment (CPE). The VPN device 422 may provide some network functions directly to the network 18, either as a hardware service provider or as a service hub for a virtual service container 502. In some embodiments, at least some virtual network functions may be provided to the network 18 from a remotely-executed virtual service container 502. For example, the VPN device 422 may initiate a virtual private network (VPN) connection 420 to the service hub 402 (e.g., to a virtual service container 502 executing at the service hub 402). The VPN connection 420 may be made according to any suitable VPN protocol or configuration. In some embodiments, in lieu of a VPN connection 420, the device 422 may initiate another type of secure connection 420 to the service hub 402. The VPN device 422 may be provided by an administrator of the network 18 and/or by a party providing the network functions. The VPN connection 420 may be made across the Internet 16, which accessible to the network 18 via the ISP 400 (FIG. 3). As illustrated, however, the configuration 411 may be implemented without the direct involvement of the Internet service provider (ISP) 400. For example, it may not be necessary to place a service hub 402 within the ISP's network 400. Also, in some embodiments, the VPN device 422 or other suitable consumer premises equipment at the gateway position of the LAN 18 may act as a service provider 14 and provide some network functions to the LAN 18 while virtual service containers 502 executed at the service hub 402 provide additional network functions.

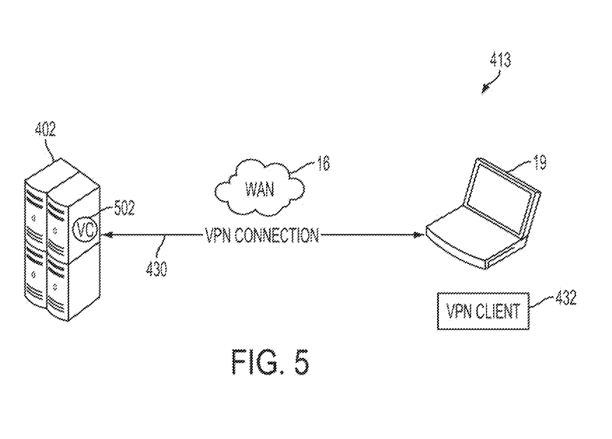

FIG. 5 is a block diagram showing one embodiment of a network configuration 413 for routing network traffic from a managed user device 19 to a virtual service container 502 executed at a service hub 402. In the configuration 413, the user device 19 executes a VPN client 432 for supporting a VPN connection 430 between the user device 19 and the service hub 402, e.g., between the user device 19 and a virtual service container 502 executed at the service hub 402 as described herein. The VPN connection 430 may be according to any suitable type of VPN protocol or configuration and, in some embodiments, may be replaced with any other suitable type of secure connection. In some embodiments, the configuration 413 may provide the user device 19 with access to an associated LAN 18. For example, the service hub 402 or virtual service container 502 executed thereon may be in direct or indirect communication with the LAN 18, allowing the user device 19 to access the LAN 18 via the service hub 402.

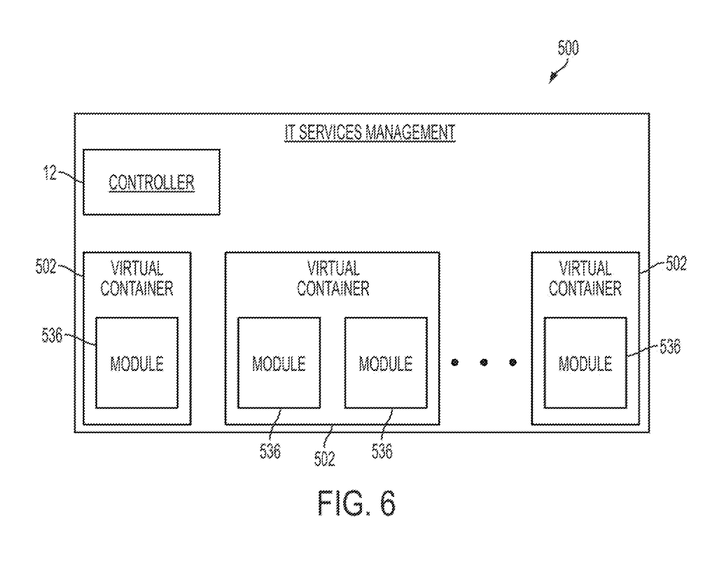

FIG. 6 is a block diagram showing one embodiment of a network functions or network function management system 500. The system 500 may be executed by one or more servers or other computer devices that may be at a single geographic location or distributed across multiple geographic locations, as described herein. The system 500 may comprise one or more controllers 12 and one or more virtual service containers 502. Each virtual service container 502 may be executed to provide virtual network functions a managed component, such as a managed LAN 18 and/or one or more managed user devices 19 as described herein with respect to FIG. 1. In various embodiments, the respective components 12, 502 of the system 500 may be executed as virtual machines executing on one or more service hubs 402 as described herein. The virtual machines may be configured according to any suitable virtual machine protocol such as, for example, those available from VMWARE and VM VIRTUAL BOX available from ORACLE. For example, virtual service containers 502 may be under the management of a hypervisor, with different hypervisors operating and communicating according to different protocols. In various embodiments, virtual service containers 14 comprise one or more modules 536, which may be programmed to different virtual network functions to managed components. In some embodiments, virtual service containers 502 providing virtual network functions to the same network 18 and/or user device 19 may be grouped together under a common classification.

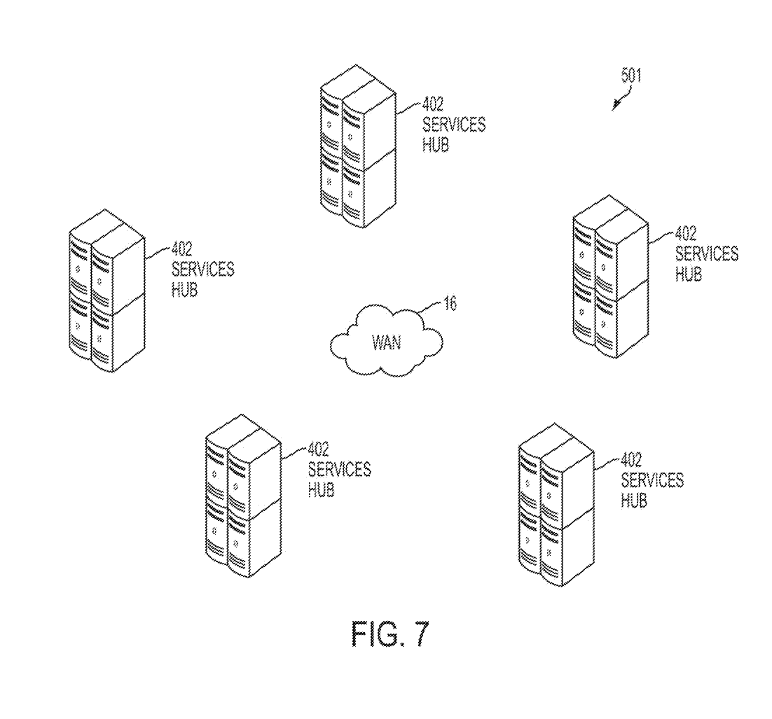

The system 500 may be implemented utilizing one or more service hubs 402. As described herein, a service hub 402 is a hardware location where a virtual service container 502 and/or controller 12 may be executed. In places herein, a service hub 402 is also referred to as a tenant. FIG. 7 is a diagram showing one embodiment of an environment 501 for implementing the system 500 comprising multiple distributed services hubs 402. The service hubs 402 may be geographically distributed. For example, different countries or geographic areas may comprise a local services hub or hub 402. Service hubs 402 may be of various different types. For example, as shown in FIGS. 2 and 3, some service hubs or tenants 402 are positioned within in an Internet service provider network 400 of an Internet service provider. Some service hubs 402 may be positioned at non-public data centers such as, for example, data centers maintained by the proprietor of the network functions management system 500. Service hubs 402 may also be positioned at commercially available processing depots such as, for example, GOOGLE CLOUD, GOOGLE COMPUTE ENGINE, AMAZON WEB SERVICES, AMAZON EC2, etc. In some embodiments, a service hub 402 may be positioned within a managed network, device or other component, such as a server, an edge network device 406, a VPN device 422, etc. In some embodiments, virtual service containers 502 may be implemented across different service hubs 402. For example, one virtual service container 502 may be executed at a service hub 402 at a Internet service provider network 400 while another virtual service container 502 may be executed at a different service hub 402 at a commercial processing depot. In some embodiments, multiple virtual service containers 502 may be executed on different service hubs 402 that are located at a single geographic location. For example, some data centers may comprise multiple service hubs 402, where each service hub 402 comprises a distinct server/device or a distinct logical grouping of servers/devices.

Each service hub 402 may execute one or more virtual service containers 502, for example, under the supervision of a controller 12. The controller 12 may be executed at the same geographic location as the service hub 402 and/or at a different location. In some embodiments, the controller 12 may instantiate virtual service containers 502 to provide virtual network functions to a managed component (e.g., a managed network 18 and/or managed user device 19) based on the geographic location of the network 18 and/or user device 19. For example, the controller 12 may be implemented on a service hub 402 at a fixed geographic location (e.g., near the geographic locus of the customer implementing the network 18). When a user device 19 associated with the network 18 travels to a different geographic location and attempts to access the virtual network functions, the controller 12 may instantiate a new virtual service container 502 at a service hub 402 that is closer, geographically, to the user device 19. Control of the virtual service container 502 may still be maintained at the, now remote, controller 12. In this way, network latencies may be reduced. Also, for example, other virtual service containers 502 may be maintained near the geographic locus of the network 18 to continue to provide virtual network functions to the devices on the network 18.

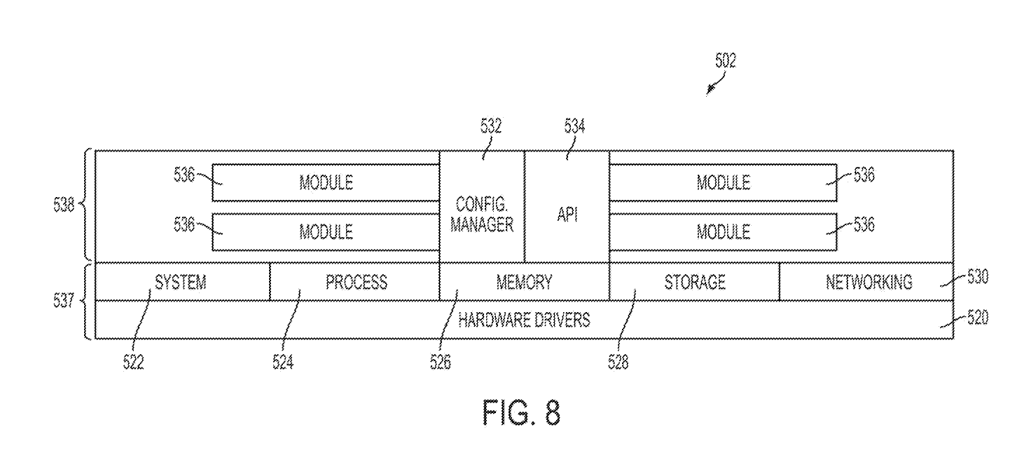

Each virtual service container 502 may be configurable to provide various virtual network functions to a managed component or components. FIG. 8 is a system diagram showing one embodiment of a virtual service container 502. For example, virtual service containers 502 may be implemented according to a just enough operating system (JeOS) format. An operating system (OS) core 537 may comprise minimal components that may include, for example, hardware drivers 520, system services 522, process services 524, memory services 526, data storage services 528, and networking support 530. Hardware drivers 520 may comprise low-level software acting as an interface to the physical hardware (and/or physical hardware as emulated by the hypervisor). The hardware drivers 520 may provide an interface to software above allowing the software above to manipulate the behavior of the hardware, for example, through the hypervisor. Process services 524 may control the creating, scheduling, termination, etc. of the software components, such as service modules 536 and associated components. Memory services 526 may handle the allocation and de-allocation of physical and virtual memory to processes that request it. Storage services 528 may handle creation, access, and removal of files and data on the physical disk media such as a hard drive, a solid-state drive, etc. Networking services 526 may provide abstracted access to network operations and control structures to processes. System services 522 may provide low-level operating system services such as scheduling, command execution, command line, boot, etc. The various OS core 537 components may be in communication with a hypervisor (not shown) executed by the service hub 402 executing the virtual service container 502. It will be appreciated that the OS core 537 components may be and/or utilizing any suitable operating system or operating system portions including, for example, LINUX or any suitable UNIX-based operating system, any suitable version of the WINDOWS operating system, any suitable version of the MAC OS operating system, etc.

Above the OS core 537 components, the virtual service container 502 may execute one or more service modules 536 for providing virtual network functions. In this way, the virtual service container 502 may act as a virtual secure container that is in secure communication with one or more managed components and is a container for the various service modules 536. The service modules 536 may be supported by a configuration management service 532 and an application programming interface or API 534. The configuration management service 532 may manage the initiation, configuration, and shut-down of the various service modules 536, for example, based on instructions received from the controller 12 as described herein. For example, the virtual service container 502 may be configured to allow the various service modules 536 to be instantiated, modified and/or shut-down without affecting the operation of other modules 536 at the virtual service container. The API 534 may facilitate the operation of the various service module 536 under the direction of the OS core 537 components. In some embodiments, the configuration management service 532 may be and/or utilize the open source tool SALT STACK. Also, in some embodiments, the functionalities of the configuration module 532 and the API 534 may be combined in a single component.

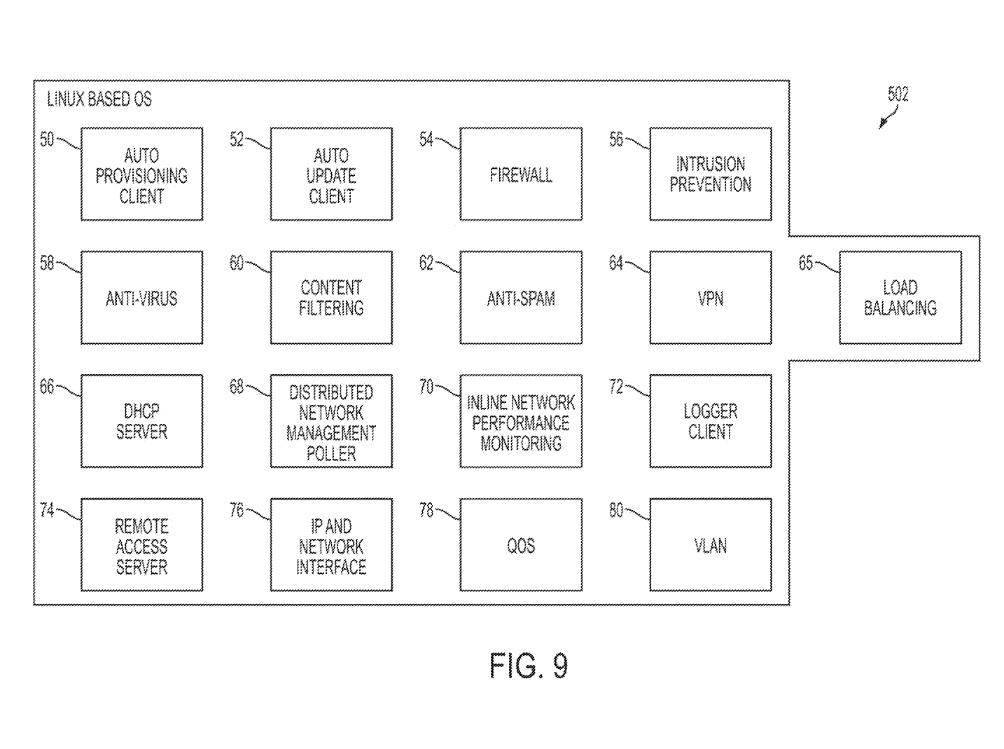

FIGS. 9-14 illustrate network functions that may be provided utilizing service providers 14, such as hardware service providers and/or virtual service containers 502 executed at a tenant or service hub 402. FIG. 9 is a block diagram of a virtual services container provider 502 showing various example service modules 536 for providing virtual network functions. Virtual service devices 502 may comprise some, all, or any combination of these and other service modules for performing virtual network functions. It will be appreciated that hardware-based service providers may provide similar network functions. The virtual service container 502 comprises an auto-provisioning client 50, an auto-update client 52, a firewall module 54, an intrusion prevention module 56, an anti-virus module 58, a content filtering module 60, an anti-spam module 62, a virtual private networking (VPN) module 64, a dynamic host configuration protocol (DHCP) server module 66, a distributed network management poller module 68, an inline network performance monitoring module 70, a logger module 72, a remote access server module 74, an Internet protocol (IP) and network interface module 76, a quality of service (QOS) module 78, and a virtual local area network (VLAN) module 80.

In some embodiments, a services provider 14 may also comprise a load-balancing module 65. The load-balancing module 65 is operable to provide load-balancing functionality. For example, according to various embodiments, the load-balancing module of the virtual service container 502 allows for the provider 14 to provide a network traffic redirection function that sends traffic to a different destination depending on the specific load characteristics of the incoming traffic. According to various embodiments, the load balancing module allows for the integration of the provider 14 and a load-balancing client installed on one or more devices that comprise a portion of the local area network 18. The load-balancing module allows for the provider 14 to route traffic to different destinations based on but not limited to least-recently used, round-robin, least loaded, etc.

The auto-provisioning module or client 50 is operable to provide auto-provisioning functionality. For example, according to various embodiments, the auto-provisioning client 50 allows for the provider 14, and its various virtual service containers 502, to be auto-configured based on an activation code entered by an installer during creation of the provider 14, as described herein. The auto-update module or client 52 is operable to provide an auto-update function to the managed component. For example, according to various embodiments, the auto-update module 52 allows for the virtual service device 502 to be automatically updated whenever updates are available. The updates may include, for example, operating system updates, intrusion prevention rule updates, anti-virus signature updates, and content filtering database updates. For example, the auto-provisioning client 50 and auto-update client 52 may be implemented, for example, by the core OS components 536 and/or configuration management 532 and/or API 534 module

The firewall module 54 is operable to provide firewall virtual network functions. For example, according to various embodiments, the firewall module 54 allows for the virtual service container to perform deep packet inspection, stateful inspection, network address translation, port address translation and port forwarding.

The intrusion prevention module 56 is operable to provide intrusion prevention functionality. For example, according to various embodiments, the intrusion prevention module 56 allows for the virtual service container 502 to perform real-time traffic analysis and logging, protocol analysis, and content searching and matching. The intrusion prevention module 56 may also allow for the virtual service container 502 to detect a variety of attacks and probes such as, for example, buffer overflows, operating system fingerprinting attempts, common gateway interface attacks and port scans.

The anti-virus module 58 is operable to provide anti-virus functionality. For example, according to various embodiments, the anti-virus module 58 of the virtual service container 502 allows for the provider 14 to provide an Internet gateway protection service that protects against viruses and malicious code that may be downloaded from the Internet 16 to the local area network 18 or user device 19. According to various embodiments, the anti-virus module 58 of the virtual service container 502 allows for the integration of the virtual service container 502 and an anti-virus client installed on one or more devices that comprise a portion of the managed components. The anti-virus module 58 allows for the virtual service container 502 to block access to the Internet 16 for any device of the local area network 18 that does not have the most current anti-virus client and anti-virus signature database installed thereon. The anti-virus module 58 of the virtual service container 502 may redirect such blocked devices to a webpage that will allow for the device to be updated to include the most current anti-virus client and anti-virus signature database.

The content filtering module 60 is operable to provide content filtering functionality. For example, according to various embodiments, the content filtering module 60 allows for the virtual service container 502 to act as a transparent proxy which inspects each request made from the local area network 18 to the Internet 16. The content filtering module 60 may determine whether to grant or deny the request to access a particular website based on defined policies. For instances where the request is granted, the content filtering module 60 may further determine which types of files are allowed to be downloaded from the Internet 16 to the local area network 18. According to various embodiments, each policy may be defined as a blacklist or a whitelist. If the policy is defined as a blacklist, the content filtering module 60 operates to allow access to all sites except those explicitly defined to be blocked. If the policy is defined as a whitelist, the content filtering module 60 operates to block access to all sites except those explicitly defined to be allowed.

The anti-spam module 62 is operable to provide anti-spam and e-mail anti-virus functionality. For example, according to various embodiments, the anti-spam module 62 allows for the virtual service container 502 to act as a transparent proxy, which inspects each e-mail message that transits the virtual service container 502 for viruses and malicious code. If the anti-spam module 62 identifies an e-mail as SPAM, the virtual service container 502 may block the e-mail. If the anti-spam module 62 identifies an e-mail as containing a virus, the virtual service container 502 may attempt to disinfect the e-mail. If the e-mail is cleaned, the virtual service container 502 may forward the cleaned e-mail along with a message that the e-mail contained a virus. If it is not possible to disinfect the e-mail, the virtual service container 502 may block the e-mail.

The VPN module 64 is operable to provide VPN functionality. For example, according to various embodiments, the VPN module 64 provides the encryption protocol for the automatic building of a site to site VPN which is implemented as a secure tunnel that connects two different virtual service containers 502. A secure socket layer (SSL) is used to create the encrypted tunnel between the two providers 14. In instances where a virtual service container 502 is assigned a new WAN IP Address, the VPN module 64 allows for all of the tunnels connecting the virtual service container 502 to other virtual service containers 502 to automatically reconfigure themselves to establish new tunnels to the provider 14 at the new IP Address. According to various embodiments, the VPN module 64 of the virtual service container 502 allows for the cooperation of the virtual service container 502 and a remote access client.

The DHCP server module 66 is operable to provide DHCP server functionality. For example, according to various embodiments, the DHCP server module 66 allows the virtual service container 502 to provide IP addresses and configuration parameters to network devices requesting this information using the DHCP protocol. IP address pools with characteristics such as default gateways, domain names, and DNS servers can be defined. Static assignments can also be defined based on MAC address.

The distributed network management poller module 68 is operable to provide distributed network management poller functionality. For example, according to various embodiments, the distributed network management poller module 68 allows the virtual service container 502 to poll network elements that comprise a portion of a local area network 18 and are in communication with the virtual service container 502. For example, the distributed network management poller module 68 may utilize Internet control message protocol pings to determine a reachability value and a latency value for one or more of the network elements. The distributed network management poller module 68 may also utilize simple network management protocol (SNMP) to poll SNMP information from network elements that are SNMP capable. Such SNMP information may include, for example, CPU utilization or server temperature.

The inline network performance monitoring module 70 is operable to provide inline network performance monitoring functionality. For example, according to various embodiments, the inline network performance monitoring module 70 allows the virtual service container 502 to inspect each packet that transits the virtual service container 502 and record certain information such as source/destination IP address, protocol, and source/destination ports. According to various embodiments, the inline network performance monitoring module 70 also allows the provider 14 to monitor all network traffic that passes between the virtual service container 502 and another virtual service container 502. Each virtual service container 502 has its time synchronized precisely to network time protocol servers (not shown). This allows for each virtual service container 502 to reference packet information with a common time reference. According to various embodiments, the inline network performance monitoring module 70 can record the exact time every packet leaves a virtual service container 502, and record items such as, for example, source/destination IP address, protocol, sequence number and source/destination port. As the packets travel across the Internet 16, the packets eventually reach the destination virtual service container 502. The inline network performance monitoring module 70 of the destination virtual service container 502 records the exact time the packet is received by the destination virtual service container 502 and items such as, for example, source/destination IP address, protocol, sequence number and source/destination port.

The logger module 72 is operable to provide logging functionality. For example, according to various embodiments, the logger module 72 allows information obtained by the virtual service container 502 (e.g., intrusion prevention detections, anti-virus detections, network device polling results, source/destination IP addresses, application performance measurements, etc.) to be recorded, processed and transmitted to the controller 12. According to various embodiments, the data collected by the inline network management monitoring module 70 of each provider 14 is forwarded to the logger module 72 of the associated provider 14. After receiving the data, the logger modules 72 wait a random amount of time (e.g., between approximately 120 and 240 seconds) before transmitting the data to the controller 12. This random delay is to prevent all the virtual service containers 502 from sending their data back to the controller 12 at the same time. If the controller 12 cannot be reached, the virtual service container 502 may queue the data locally until the controller 12 can be reached. When the controller 12 is reached, the logger module 72 will transmit all of the queued data. The data that is transmitted uses a system queue which insures that regular user network traffic will always have priority and this data transfer will only use the unused bandwidth on the network connection.

The remote access server module 74 is operable to provide remote access capability. For example, according to various embodiments, the remote access server module 74 allows for the cooperation of the virtual service container 502 with a remote access client.

The IP and network interface module 76 is operable to provide capability to configure the network interface characteristics such as IP Address type (e.g., static IP, DHCP, or PPPOE), IP address, subnet mask, speed and duplex. The IP and network interface module 76 is also operable to provide the provider 14 with the capability to configure IP routing. In some embodiments, IP and network interface services may be handled virtually by the virtual service container 502.

The QOS module 78 is operable to provide QOS functionality. For example, according to various embodiments, the QOS module 78 allows the virtual service container 502 to selectively transmit packets based on the relative importance of the packet. The QOS module 48 may also allow the virtual service container 502 to inspect each packet and determine a particular queue to send the packet to based on defined rules. Rules may be defined, for example, based on source/destination IP address and/or port information. If a packet does not match any rule, it may be sent to a default queue.

The VLAN module 80 is operable to provide VLAN functionality. For example, according to various embodiments, the VLAN module 80 allows the virtual service container 502 to connect to many different VLANS from an Ethernet switch that has enabled trunking.

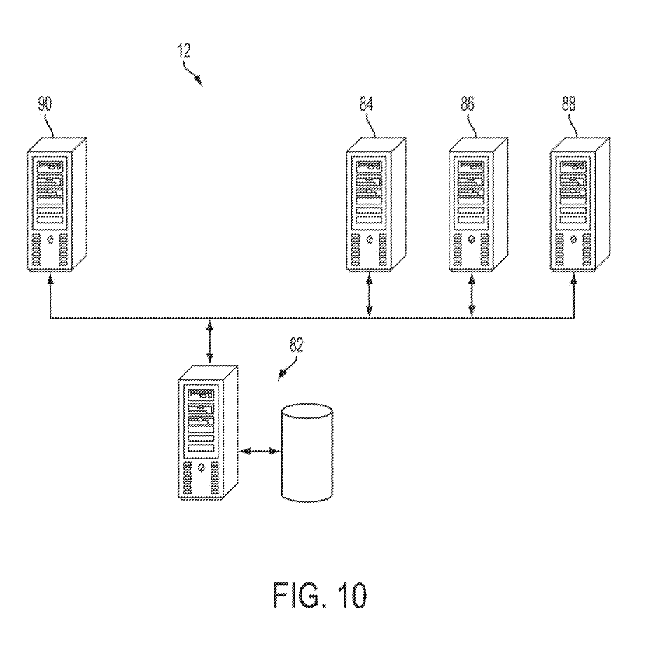

FIG. 10 is a block diagram showing one example embodiment of an implementation of the controller 12 of FIG. 1. It will be appreciated that FIGS. 10-13 show just one example way to arrange the controller 12. In the example of FIG. 10, the controller 12 includes a database cluster 82, an activation server 84, a logger server 86, a manager server 88 and a web-based management portal 90. The controller 12 may be located external to any customer sites and may provide a shared infrastructure for multiple customers. For example, the controller may be executed at a service hub 402, as described herein above. The various components 82, 84, 86, 88, 90 of the controller 12 may be implemented by separate hardware servers and/or executed as virtual machines on one or more service hubs 402. According to various embodiments, the database cluster 82 includes a plurality of databases and structural query language (SQL) servers. According to various embodiments, the database cluster 82 includes a combination of structural query language servers and open source MySQL servers. The databases hold all of the data required by the activation server 84, the logger server 86, the manager server 88 and the web-based management portal 90.

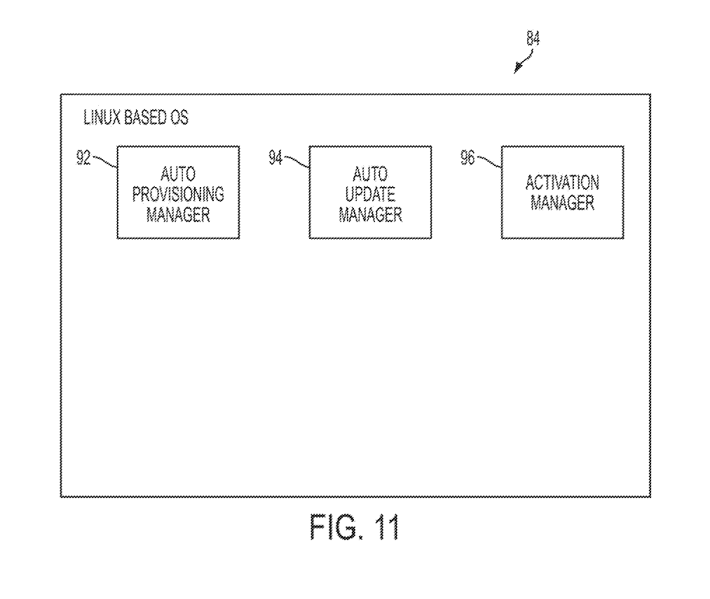

FIG. 11 is a block diagram showing one embodiment of the activation server 84 of FIG. 10. The activation server 84 may include a Linux based operating system, and may include an auto-provisioning manager module 92, an auto-update manager module 94 and an activation manager module 96. The auto-provisioning manager module 92 is operable to configure any service provider 14 (e.g., hardware or virtual secure container 502) that is in the process of being activated. The auto-update manager module 94 is operable to update the operating system of any virtual service container 502 that is in the process of being activated. The auto-update manager module 94 is also operable to update the various databases and signature files used by modules resident on a virtual service container 502 (e.g., intrusion prevention, anti-virus, content filtering, etc.). The activation manager module 96 is operable to communicate with the back-end SQL servers of the database cluster 82 to gather the necessary data required by the auto-provisioning manager module 92 to generate device configurations. The activation manager module 96 is also operable to authenticate incoming virtual service containers 502 and determine their identity based on the activation key.

According to various embodiments, the activation server 84 is a collection of hosted servers that are utilized to set up the initial configuration of each virtual service container 502. Based on an activation key received from the virtual service container 502 when the virtual service container 502 is first activated, the activation server 84 automatically sends the appropriate configuration to the virtual service container 502, for example, as described herein below. The activation server 84 also may assign the virtual service container 502 to a redundant pair of logger servers 86 and a redundant pair of manager servers 88.

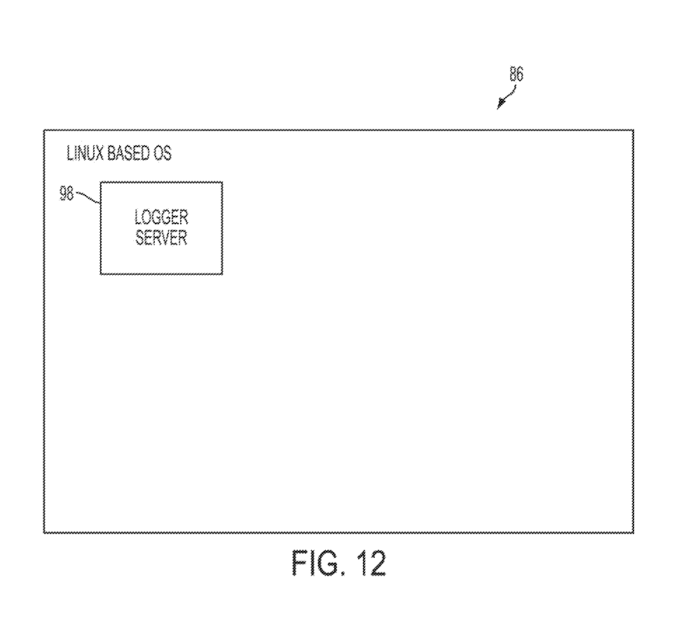

FIG. 12 is a block diagram showing one embodiment of the logger server 86 of FIG. 10. The logger server 86 may include a Linux based operating system and a logger server module 98. According to various embodiments, the logger server 86 is a collection of hosted servers that receive log information from the virtual service container 502 and correlates the information.

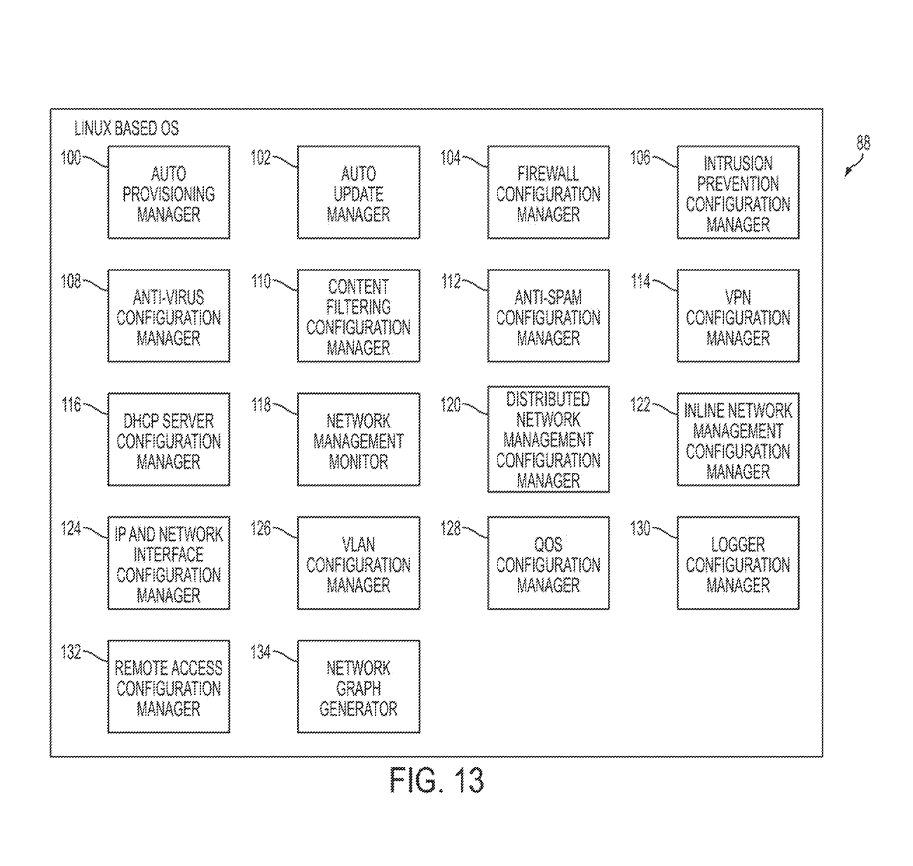

FIG. 13 illustrates various embodiments of the manager server 88. The manager server 88 may include a Linux based operating system and the following modules: an auto-provisioning manager module 100, an auto-update manager module 102, a firewall configuration manager module 104, an intrusion prevention configuration manager module 106, an anti-virus configuration manager module 108, a content filtering configuration manager module 110, an anti-spam configuration manager module 112, a VPN configuration manager module 114, a DCHP server configuration manager module 116, a network management monitor module 118, a distributed network management configuration manager module 120, an inline network management configuration manager module 122, an IP and network interface configuration manager 124, a VLAN configuration manager module 126, a QOS configuration manager module 128, a logger configuration manager module 130, a remote access configuration manager module 132, and a network graph generator module 134. In some embodiments, the IP and network configuration manager 124 may be automatically set as a system-level setting and may not be accessible to the user.

According to various embodiments, the manager server 88 is a collection of servers that are utilized to manage the providers 14 (e.g., hardware providers 14 and/or virtual service containers 502). The manager server 88 transmits the configuration and the updates to the providers 14. The manager server 88 also monitors the provider 14, stores performance data, and generates graphs for the provider 14 and each network element monitored by the provider 14. For example, the auto-update manager module 102 may periodically poll each virtual service container 502 and determine whether the virtual service containers 502 have the most current version of the core OS 536 components, the anti-virus signature database, the content filtering database and the intrusion protection database. If the auto-update manager module 102 determines that a particular virtual service container 502 does not have the most current version of the operating system and databases, the auto-update manager module 102 operate to will automatically transmit the appropriate update to the device 502. Similar polling and updating may be performed for hardware service providers.

The VPN configuration manager module 114 may automatically configure the VPN tunnels for each service provider 14. For example, each virtual service container 502 may form a VPN tunnel or connection to the controller 12 during the provisioning process, as described herein. When the particular virtual service container 502 is first activated, the virtual service container 502 contacts the manager server 88 and reports its public Internet address. The auto-provisioning manager module 100 records the reported address and stores it in the database cluster 82. The VPN configuration manager module 114 may also gather all of the VPN configuration information from the database cluster 82 for each virtual service container 502 that is provisioned. The VPN configuration manager module 114 may also create configuration files for each of the virtual service containers 502. After the manager server 88 transmits the configurations to each of the virtual service containers 502, secure encrypted tunnels are established between each of the virtual service containers 502. For example, two virtual service containers 502 may have a VPN tunnel or connection between one another if both virtual service containers 502 provide virtual network functions to the same network 18 and/or user device 19.

When a particular virtual service container 502 is issued a new IP address, the virtual service container 502 may automatically transmit its new IP address to the manager server 88. The auto-update manager module 102 responds to this IP address change and automatically generates new configurations for all of the virtual service containers 502 that have secure communication link to the particular virtual service container 502. The VPN configuration manager module 114 automatically transmits the new configurations to the providers 14 and the encrypted tunnels automatically reconverge. VPN for hardware service providers may be configured in a similar manner.

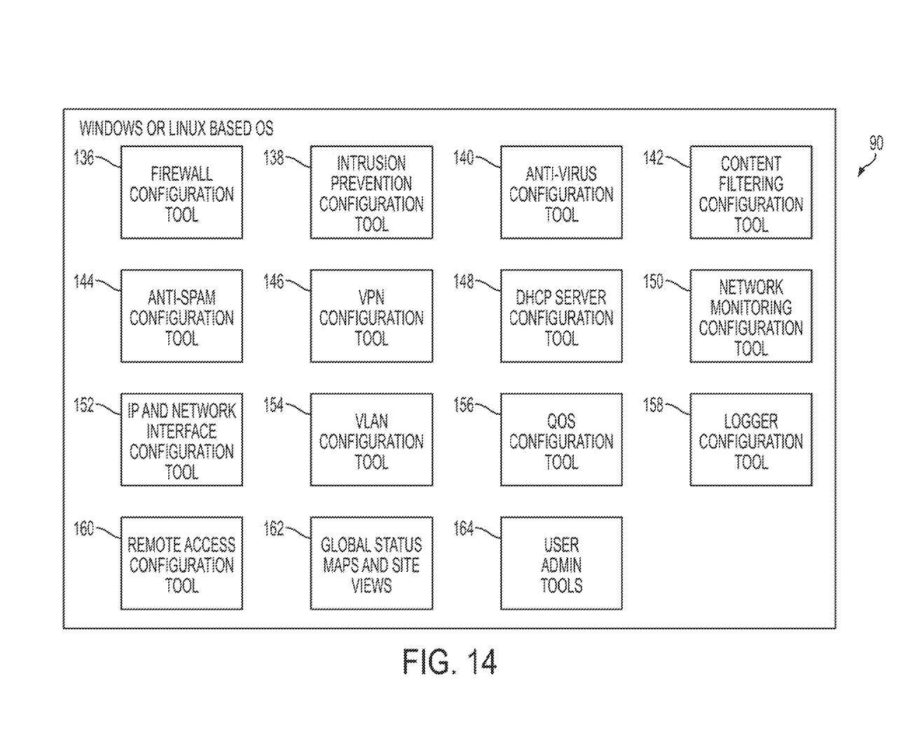

FIG. 14 illustrates various embodiments of the web-based management portal 90. The web-based management portal 90 may include a Windows or Linux based operating system and the following modules: a firewall configuration tool module 136, an intrusion prevention configuration tool module 138, an anti-virus configuration tool module 140, a content filtering configuration tool module 142, an anti-spam configuration tool module 144, a VPN configuration tool module 146, a DHCP server configuration tool module 148, a network monitoring configuration tool module 150, an IP and network interface configuration tool module 152, a VLAN configuration tool module 154, a QOS configuration tool module 156, a logger configuration tool module 158, a remote access configuration tool module 160, a global status maps and site views module 162 and a user administration tool module 164.

According to various embodiments, the web-based management portal 90 includes a collection of integrated centralized network management systems and a grouping of customer management tools. According to various embodiments, the web-based management portal 90 is a combination of many different web servers running Microsoft Internet Information Server or Apache. The web pages may be written in Microsoft's ASP.NET or PHP, and the web applications may interface with the SQL servers of the database cluster 82 to synchronize changes to the network environment as changes are made to the configuration of the providers 14 via the web-based management portal 90. The web-based management portal 90 may further include the capability for firewall management, intrusion prevention management, anti-virus management, content filtering management, anti-spam management, site to site and remote access virtual private network management, network monitoring, network configuration, account management and trouble ticketing.

The firewall configuration tool module 136 allows for centralized management of the firewall policies for each provider 14 (e.g., hardware providers and/or virtual service containers). According to various embodiments, the firewall for a given local area network 18 resides on the provider 14 associated with the given local area network 18. The firewall configuration tool module 136 allows a user to efficiently and securely manage all of the firewalls and define global policies that are easily applied to all firewalls at once. The firewall configuration tool module 136 also allows the customer to set custom firewall polices to each individual firewall. Each firewall can also have individual user permissions to restrict which user accounts can modify which firewalls. This capability may provide an administrator of each network 18 each site the ability to manage their own firewall and yet restrict them from changing the configuration of any other firewalls in the network. A notification can be automatically sent to a group of administrators every time a change is made to a firewall policy. A firewall validation tool allows a user to run a security check against their current firewall settings and report on which ports are open and any vulnerabilities that are detected. The firewall configuration tool module 136 may also be used to view firewall log information.

The intrusion prevention configuration tool module 138 allows for the centralized management of the intrusion prevention rules for each provider 14. According to various embodiments, the intrusion prevention system for a given local area network 18 resides on a service provider 14 associated with the given local area network 18. The intrusion prevention configuration tool module 138 allows a user to efficiently and securely manage all of the intrusion prevention systems and define global policies that are easily applied to all intrusion prevention systems at once. The intrusion prevention configuration tool module 138 also allows the customer to set custom intrusion prevention rules to each individual intrusion prevention system. Each intrusion prevention system can also have individual user permissions to restrict which user accounts can modify which intrusion prevention system. This capability may provide an administrator at each managed component the ability to manage their own intrusion prevention system and yet restrict them from changing the configuration of any other intrusion prevention systems in the network. An e-mail notification can be automatically sent to a group of administrators every time a change is made to an intrusion prevention system configuration. The intrusion prevention configuration tool module 138 may also be used to view intrusion protection log information.

The anti-virus configuration tool module 140 allows for the centralized management of the anti-virus policies for each provider 14 (e.g., hardware providers and/or virtual service containers 502). According to various embodiments, the anti-virus service includes two anti-virus systems. The first anti-virus system for a given local area network 18 may be embodied as an anti-virus gateway service that resides on a provider 14 associated with the given local area network 18. The second anti-virus system is a desktop anti-virus agent that resides on one or more customer computers (e.g., user devices 19) that require anti-virus protection. The anti-virus configuration tool module 140 allows a user to efficiently and securely manage both of the anti-virus systems and define global policies that are easily applied to all anti-virus systems at once. The anti-virus configuration tool module 140 also allows a user to set custom anti-virus policies to each individual anti-virus gateway. Each anti-virus system can also have individual user permissions to restrict which user accounts can modify which anti-virus system. This capability may provide an administrator at each site the ability to manage their own anti-virus policies and yet restrict them from changing the configuration of any other anti-virus systems in the network. An e-mail notification can be automatically sent to a group of administrators every time a change is made to an anti-virus system configuration. The anti-virus configuration tool module 140 may also be used to view anti-virus log information.

The content filtering configuration tool module 142 allows for the centralized management of the content filtering policies for each provider 14. According to various embodiments, the content filtering system for a given local area network 18 resides on a provider 14 associated with the given local area network 18. The content filtering configuration tool module 142 allows a user to efficiently and securely manage all of the content filtering systems and define global policies that are easily applied to all content filtering systems at once. The content filtering configuration tool module 142 also allows the customer to set custom content filtering policies to each individual content filtering system. Each content filtering system can also have individual user permissions to restrict which user accounts can modify which content filtering system. This capability may provide an administrator at each site the ability to manage their own content filtering system and yet restrict them from changing the configuration of any other content filtering systems in the network. An e-mail notification can be automatically sent to a group of administrators every time a change is made to a content filtering system configuration. The content filtering configuration tool module 142 may also be used to view content filtering log information.

The anti-spam configuration tool module 144 allows for the centralized management of the anti-spam policies for each provider 14 (e.g., hardware providers and/or virtual service containers 502). According to various embodiments, the anti-spam system for a given local area network 18 resides on a provider 14 associated with the given local area network 18. The anti-spam configuration tool module 144 allows a user to efficiently and securely manage all of the anti-spam systems and define global policies that are easily applied to all anti-spam systems at once. The anti-spam configuration tool module 144 also allows a user to set custom anti-spam policies to each individual anti-spam system. Each anti-spam system can also have individual user permissions to restrict which user accounts can modify which anti-spam system. This capability may provide an administrator at each site the ability to manage their own anti-spam system and yet restrict them from changing the configuration of any other anti-spam systems in the network. A notification can be automatically sent to a group of administrators every time a change is made to an anti-spam system configuration. The anti-spam configuration tool module 144 may also be used to view anti-spam log information.

The VPN configuration tool module 146 allows for the centralized management of the VPN policies for each provider 14 (e.g., hardware provider and/or virtual services container 502). According to various embodiments, the VPN system for a given local area network 18 resides on a provider 14 associated with the given local area network 18. The VPN configuration tool module 146 allows a user to efficiently and securely manage all of the VPN systems and define global policies that are easily applied to all VPN systems at once. The VPN configuration tool module 146 also allows a user to set custom VPN policies to each individual VPN system. Each VPN system can also have individual user permissions to restrict which user accounts can modify which VPN system. This capability may provide an administrator at each site the ability to manage their own VPN system and yet restrict them from changing the configuration of any other VPN systems in the network. A notification can be automatically sent to a group of administrators every time a change is made to a VPN system configuration.

The DHCP server configuration tool module 148 allows for the centralized management of the DHCP server policies for each provider 14 (e.g., hardware provider and/or virtual services container 502). According to various embodiments, the DHCP server for a given local area network 18 resides on a provider 14 associated with the given local area network 18. The DHCP server configuration tool module 148 allows a user to efficiently and securely manage all of the DHCP servers and define global policies that are easily applied to all DHCP servers at once. The DHCP server configuration tool module 148 also allows a user to set custom DHCP server policies to each individual DHCP server. Each DHCP server can also have individual user permissions to restrict which user accounts can modify which DHCP server. This capability may provide an administrator at each site the ability to manage their own DHCP server and yet restrict them from changing the configuration of any other DHCP server in the network. A notification can be automatically sent to a group of administrators every time a change is made to a DHCP server configuration.

The network monitoring configuration tool module 150 allows for the centralized management of the network monitoring policies for each provider 14 (e.g., hardware provider and/or virtual services container 502). According to various embodiments, the network monitoring system for a given local area network 18 resides on a provider 14 associated with the given local area network 18. The network monitoring configuration tool module 150 allows a user to efficiently and securely manage all of the network monitoring systems and define global policies that are easily applied to all network monitoring systems at once. The network monitoring configuration tool module 150 also allows a user to set custom network monitoring policies to each individual network monitoring system. Each network monitoring system can also have individual user permissions to restrict which user accounts can modify which network monitoring system. This capability may provide an administrator at each site the ability to manage their own network monitoring system and yet restrict them from changing the configuration of any other network monitoring systems in the network. A notification can be automatically sent to a group of administrators every time a change is made to a network monitoring system configuration.

The IP and network interface configuration tool module 152 allows for the centralized management of the network configuration for each provider 14 (e.g., hardware provider and/or virtual services container 502). The centralized management of the network configuration may include, for example, managing IP Address, IP Types (static IP, DHCP, PPPOE), IP routing, Ethernet Trunking, VLANs, and QOS configuration. According to various embodiments, the IP and network interface configuration tool module 152 allows a user to efficiently and securely manage all of the providers 14. Each provider 14 can also have individual user permissions to restrict which user accounts can modify the network configuration. This capability may provide an administrator at each site the ability to manage their own network configuration and yet restrict them from changing the configuration of any other providers 14 in the network. A notification can be automatically sent to a group of administrators every time a change is made to a device network configuration.

The global status maps and site views module 162 allows an authorized user to view the real-time status of their network, providers 14 (e.g., hardware provider and/or virtual services container 502) and managed components that are monitored by the providers 14. This global status maps and site views module 162 provides a global map of the world, and countries and continents on this map are color coded to represent the underlying status of any providers 14 that reside in that region. For example a customer may have providers 14 in the United States, Japan, and Italy. If all of providers 14 and managed components monitored by the providers 14 are operating as expected, the countries on the map will be shown as green. When a provider 14 in Japan ceases to operate as expected, the portion of the map representing Japan may turn red or yellow depending on the severity of the problem. The countries on the map can be selected to drill down into a lower level map. For example, the authorized user could select the United States from the world map and be presented with a state map of the United States. The individual states may be color coded to represent the underlying status of any providers 14 that reside in that state. For each state selected, a list of the sites and providers 14 in that state may be shown. The states on the map can be selected to drill down into a lower level sub map. The lower level sub map may show for example, a particular region, city, or customer site.

The global status maps and site views module 162 may read the latest data polled for each provider 14 (e.g., hardware provider and/or virtual services container 502) and the network elements that are monitored by them. It may also check the data against preset thresholds that determine what the status of each provider 14 should be set to. It may determine the color for the lowest level map item that contains the provider 14 and set the status appropriately. The status and color for each higher level map is set to represent the status of the underlying map. The color of each map item represents the severity of the most severe problem of a provider 14 in that region. For example, if a provider 14 is not operating as expected, all of the maps that have a region that include this provider 14 will be shown as red. If a provider 14 is operating in a manner associated with the color yellow, all of the maps that have a region that include this provider 14 will be shown as yellow. A map region may only be shown as green if all providers 14 included in that map region are operating as expected.

The user administration tool module 164 allows for the centralized management of a number of functionalities. According to various embodiments, the user administration tool module 164 allows a user to set up an account profile and manage different aspects of a user profile such as name, address and account name. According to various embodiments, the user administration tool module 164 allows a user to manage all orders for secure network access platform products and services including a description and status of orders and allows a user to order additional items as well. According to various embodiments, the user administration tool module 164 allows a user to manage bills, including reading current invoices, making payment, updating billing information, downloading previous statements, and invoices.

According to various embodiments, the user administration tool module 164 allows a user to add and change user accounts, delete user accounts, change passwords, create new groups, move users into certain individuals and groups, and set permissions for those individuals and groups. The permissions may allow access to different portions of the web-based management portal 90. For example, a finance employee may be given access to only account administration tools for billing and order management. Similarly, a technical employee may be given access to only the technical sections of the web-based management portal 90 and not to billing center or order management sections. According to various embodiments, the user administration tool module 164 may allow a user to open trouble tickets, track the status of existing trouble tickets, and run some of the diagnostic tools available in the secure network access platform environment.

According to various embodiments, the controller 12 may correlate all information received from the providers 14 (e.g., hardware provider and/or virtual services container 502), including performance information.

Each of the service modules described hereinabove may be implemented as microcode configured into the logic of a processor (e.g., a virtual processor of a virtual secure container), or may be implemented as programmable microcode stored in electrically erasable programmable read only memories. According to other embodiments, the service modules 536 may be implemented by software to be executed by a processor. The software may utilize any suitable algorithms, computing language (e.g., C, C++, Java, JavaScript, Visual Basic, VBScript, Delphi), and/or object oriented techniques and may be embodied permanently or temporarily in any type of computer, computer system, device, machine, component, physical or virtual equipment, storage medium, or propagated signal capable of delivering instructions. The software may be stored as a series of instructions or commands on a computer readable medium (e.g., device, disk, or propagated signal) such that when a computer reads the medium, the described functions are performed.

Although the environment 10 is shown in FIG. 1 as having wired data pathways, according to various embodiments, the network elements may be interconnected through a secure network having wired or wireless data pathways. The secure network may include any type of delivery system comprising a local area secure network (e.g., Ethernet), a wide area secure network (e.g., the Internet and/or World Wide Web), a telephone secure network, a packet-switched secure network, a radio secure network, a television secure network, a cable secure network, a satellite secure network, and/or any other wired or wireless communications secure network configured to carry data. The secure network may also include additional elements, such as intermediate nodes, proxy servers, routers, switches, and adapters configured to direct and/or deliver data.

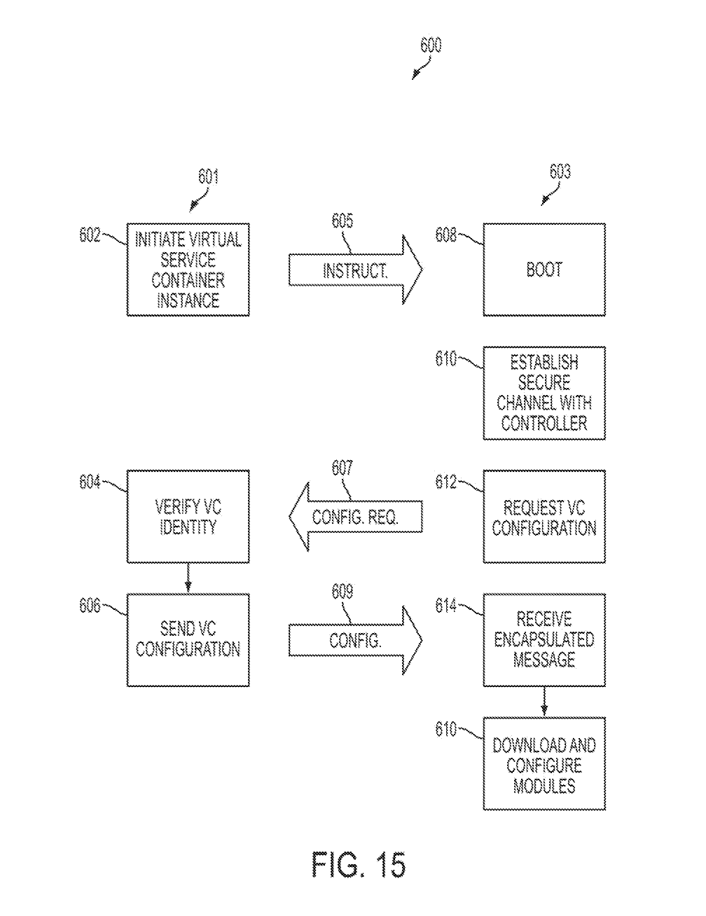

FIG. 15 is a flow chart showing one embodiment of a process flow 600 that may be executed by the controller 12 to instantiate and configure an instance of a virtual service container 502. The process flow 600 comprises a column 601 showing actions that may be performed by the controller 12 and a column 603 showing actions that may be performed by the newly instantiated virtual service container 502. At 602, the controller 12 (e.g., the activation server 84, thereof) may initiate an instance of a virtual service container 502. The virtual service container 502 may be initiated for any number of reasons including those described herein. For example, a new virtual service container 502 may be instantiated to provide virtual network functions to a new managed component (e.g., a managed network 18 and/or managed user device 19). Also, for example, a new virtual service container 502 may be instantiated to handle increased load from an existing managed component. In response to an instruction 605 to initiate, the virtual service container 502 may boot at 608. The virtual service container 502, on booting, may execute a module 536 that is programmed to interact with the controller 12 as described herein. In some embodiments, functionality for interacting with the controller is inherent in the operating system or other component of the virtual service container 502. Also, in some embodiments, a default configuration of the virtual service container may include one or more modules 536 for providing one or more default network functions.

At 610, the virtual service container 502 may establish a secure communication channel between itself and the controller 12. The secure communication channel may be a VPN channel or connection, a Secure Socket Layer (SSL) connection, or any other suitable type of secure connection. For example, establishing the secure communication channel may be a VPN connection managed by the VPN configuration manager module 114 described herein above. At 612, the virtual service container 502 may request its configuration from the controller 12 in the form of a configuration request 607 sent to the controller 12. In some embodiments, the virtual service container 502 may send an explicit request for its configuration. In other embodiments, the virtual service container 502 may send a message to the controller 12 that indicates to the controller 12 that the virtual service container 502 is ready to receive its configuration. For example, the message may comprise a unique identifier of the virtual service container 502. If the virtual secure container 502 comprises a default configuration, the request 607 may indicate that default configuration.

At 604, the controller may verify the identity of the virtual service container 502. For example, the virtual service container 502 may be associated with the unique identifier. The unique identifier may be generated by the virtual service container at boot 608 and/or provided to the virtual service container 502 via the instruction 605. In some embodiments, the unique identifier is a certificate. The certificate may be signed by the controller 12, for example, using a standard public key infrastructure (PKI). This may allow the virtual service container access the certificate and determine whether it has been intercepted or altered. The virtual service container 502 may provide the unique identifier back to the controller 12 to identify itself either with the configuration request 607 and/or in the course of establishing the secure channel at 610. When provided to the controller 12, the unique identifier may represent an activation key indicating that the virtual service container 502 is active and ready to receive its configuration. The controller 12 verifies the identity of the virtual service container 502 associated with a configuration request 607 by matching the included unique identifier/activation key with the unique identifier associated with an instruction 605 sent by the controller 12. In this way, if the controller 12 initiates a virtual service container 502 at a particular service hub 402 for a particular purpose, it may provide the proper configuration to that virtual service container 502 consistent with the desired purpose.

At 606, provided that the identity of the virtual service container 502 is verified, the controller 12 may send the virtual service container a configuration 609. In various embodiments, the configuration indicates one or more service modules 536 (FIG. 8) to be downloaded and executed by the virtual service container 502 and may, in some embodiments, also include configuration for the service modules. The virtual service container 502 may receive the configuration 609 at 614 and may download and configure the indicated service modules at 616. In some embodiments, the virtual service container 502 may have a preexisting configuration. For example, the virtual service container 502 may comprise a default configuration at the time of the boot 608, as described.

Also, in some embodiments, the controller 12 may conduct repeated polling of the virtual service container 502 for the purposes of configuration monitoring and/or updating. For example, the configuration request 607 provided to the controller 12 may comprise an indication of the virtual service container's current configuration (e.g., previously provided configuration and/or default configuration). The controller 12 may then provided an updated configuration 609, for example, based on input received from users. Also, in some embodiments, the virtual service containers 502 may be programmed to report a readiness to receive a configuration update after performing discrete tasks. For example, after the virtual service container 502 receives a configuration 609, it may execute the virtual network function or services associated with the configuration 609, for example, as described herein. When the service is completed or has reached a predetermined threshold (e.g., a threshold amount of time), the virtual service container 502 may be configured to request an additional configuration 609 or configuration update. In some embodiments, when the controller 12 polls and/or receives periodic configuration update requests from the virtual service containers 502, the communications from the virtual service containers 502 may also include status information such as, for example, CPU status, memory status, traffic status, etc.

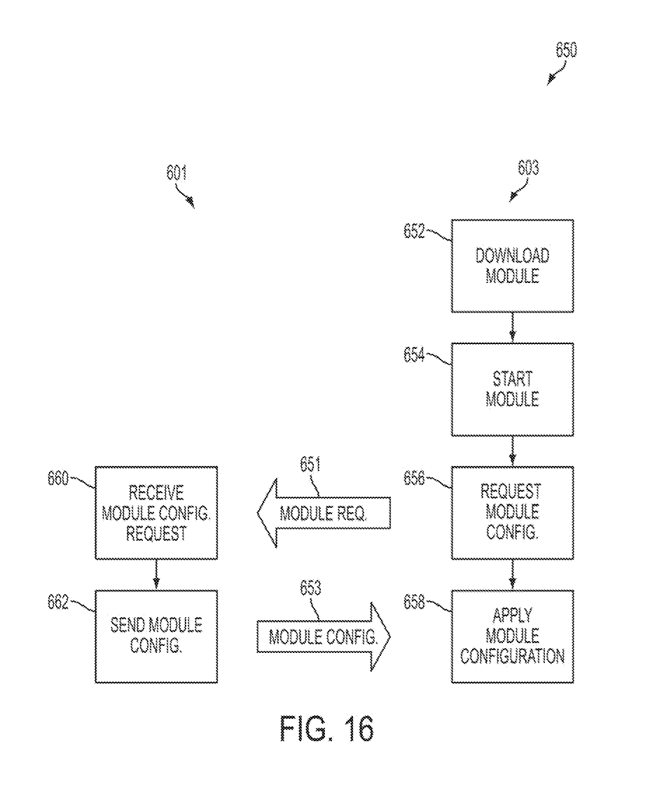

FIG. 16 is a flow chart illustrating one embodiment of a process flow 650 for downloading and configuring a service module 536 of a virtual service container 502. As with FIG. 15, the column 601 indicates actions that may be performed by the controller 12 and the column 603 indicates actions that may be performed by the virtual service container 502 (or a service module 536 thereof). The process flow 650 is one example of how the virtual service container 502 may download and configure its service modules at 616. For example, the virtual service container 502 may execute the process flow 650 for each service module indicates in its configuration 609.

Referring specifically to the process flow 650, the virtual service container 502 may download the service module 536 at 652. The service module may be downloaded from the controller 12 or from any other suitable location. At 654, the virtual service container 502 may start execution of the service module 502. At 656, upon start-up, the service module 536 and/or the virtual service container 502 may make a service module configuration request 651 directed to the controller 12. The controller 12 may receive the service module configuration request 651 at 660. In various embodiments, the controller 12 may also verify the identity of the virtual service container 502 and/or the service module 536. At 662, the controller 12 may direct a service module configuration 653 to the virtual service container 502. The virtual service container 502 may apply the service module configuration 653 at 658.

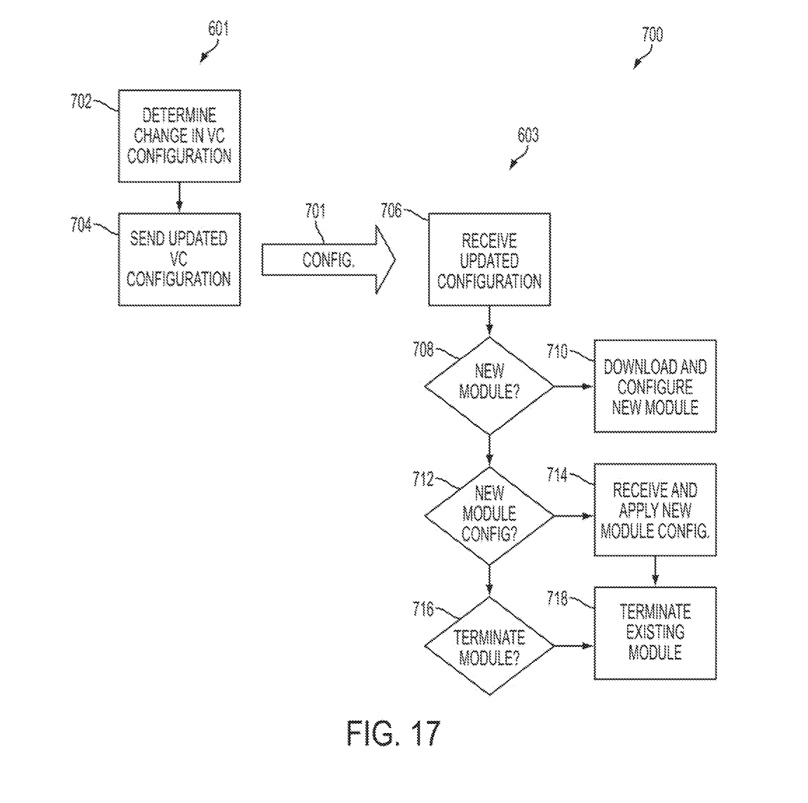

In various embodiments, the controller 12 may be configured to modify the configuration of a virtual service container 502 while it is executing and without interrupting virtual network functions provided by the virtual service container 502. The modification may be for various reasons, for example, as described herein below. FIG. 17 is a flow chart illustrating one embodiment of a process flow 700 for modifying the configuration of a virtual service container 502. In FIG. 17, column 601 includes actions that may be performed by the controller 12. Column 603 includes actions that may be performed by the virtual service container 502.

At 702, the controller 12 may determine that an operating virtual service container 502 should have its configuration changed. At 704, the controller 12 may direct a new configuration 701 to the virtual service container 12. At 706, the virtual service container 502 may receive the new configuration 701. If, at 708, the new configuration indicates that the virtual service container 502 is to execute a new service module 536, then the virtual service container 502 may download and configure the new service module 536 at 710. For example, the virtual service container 502 may download and configure the new service module 536 in the manner described herein with respect to the process flow 650 of FIG. 16. If, at 712, the new configuration 701 indicates that that the virtual service container 502 is to modify the configuration of a currently executing service module, then the virtual service container 502 may request, receive and apply the new service module configuration at 714. If, at 716, the new configuration 701 indicates that the virtual service container 502 should terminate a currently running service module 536, then the virtual service container 502 may terminate the service module 536 at 718.

It will be appreciated that the use of virtual service container 502 as described herein provides additional flexibility to the provision of virtual network functions. Because virtual network functions are provide by the modules 536 of the virtual services containers 502, it may be possible to add a new virtual network function (by adding a module 536), change the configuration of an existing virtual network function (by changing the configuration of a module 536) or eliminate an executing virtual network function (by deactivating a module 536), all without affecting any other modules 536 executed by the virtual service container 536 or their associated virtual network functions.

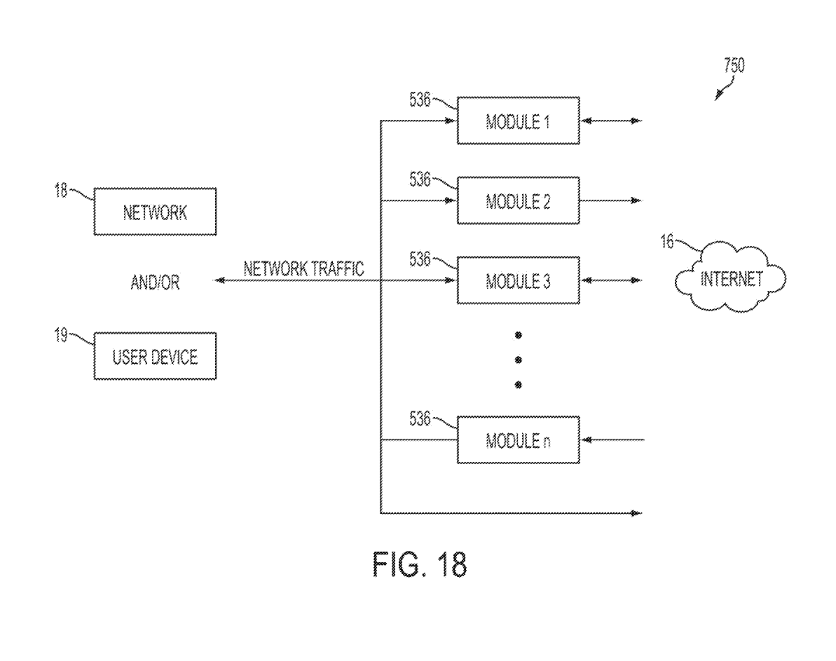

FIG. 18 is a diagram showing one embodiment of a set of virtual network functions that may be implemented by service modules 536 executed by virtual service container 502 as described herein. Each service module 536 may provide all or part of virtual network function to one or more managed components and may intercept and process network traffic directed to and/or from the managed components and Internet 16. Any suitable number of service modules 536 may be implemented. The service modules 536 shown in FIG. 18 may be executed by a single virtual service container 502 and/or by multiple virtual service container 502 (e.g., multiple virtual service containers 502 servicing common managed components). In various embodiments, each service module 536 executed by a virtual service container 502 may provide virtual network functions to a single managed component or set of managed components (e.g., a network 18 and/or user devices 19 associated with the network 18). The specific virtual network functions offered by the service modules 536 may include, for example, those services described herein above with respect to service modules of FIG. 9. Some of the service modules 536 may provide virtual network functions that require examination of outgoing and incoming network traffic. Examples of such service modules include the service module 536 labeled “service module 1” and the 536 labeled “module 3.” Other service modules 536 may require examination only of outgoing (module 2) or incoming (module n) network traffic.

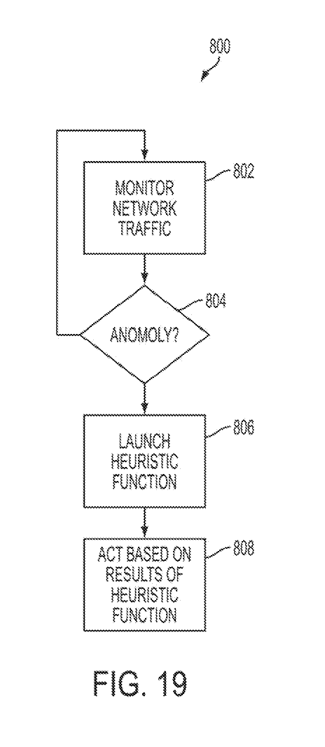

FIG. 19 is a flow chart showing one embodiment of a process flow that may be executed by various components of the environment 10 of FIG. 1 to dynamically modify virtual network functions provided to one or more managed components (e.g., a network 18 and/or user device 19). At 802, the environment 10 may monitor network traffic directed to and/or from a network 18 and/or user device 19. The monitoring may be performed, for example, by an intrusion prevention, network performance monitoring, quality of service (QOS) or other suitable IT function provided by a service module 536 executed by a virtual service container 502. If the service module 536 detects an anomaly at 804, then the environment 10 may launch an additional heuristic virtual network function to further analyze either the detected anomaly and/or continuing network traffic. For example, the service module 536, upon detection of the anomaly, may direct a message to the controller 12. The controller 12 may initiate a new service module 536 to implement the heuristic virtual network function. The new service module 536 may be initiated, for example, as described herein above with respect to FIG. 17 and may be initiated at the same virtual service container 502 that executed the service module 536 that detected the anomaly or at a different virtual service container 502. In some embodiments, the controller 12 may initiate a new virtual service container 502 and/or service module 536 to implement the heuristic function as a virtual network function.

At 808, the environment 10 may act on results of the heuristic function. For example, if the anomaly is determined to be due to a higher level of network traffic from the served network 18 and/or user device 19, the service module 536 and/or controller 12 may direct a sales prompt to pitch additional network functions to a managed component, or proprietor thereof. For example, an e-mail or other message may be sent to a customer representative or sales representative associated with the proprietor of the managed component, prompting the sales representative to offer additional network function capacity. In some embodiments, a promotional e-mail or message may be sent directly to the proprietor of the managed component. Also, for example, if the anomaly is a security breach or potential security breach, the service module 536 and/or controller 12 may direct an e-mail or other message to a network administrator or security investigator for further investigation or action. Also, for example, the controller 12 may implement a new service module 536 or virtual service container 502 and/or modify an existing service module 536 for providing security-related virtual network functions such as, for example, firewall services, anti-virus services, etc.

It will be appreciated that certain managed components (e.g., managed networks 18 and/or managed user devices 19) may only require certain virtual network functions at certain times or upon the occurrence of certain events. For example, a network 18 may perform a network intensive activity, such as data back-up, at 2:00 a.m. every night. At that time, the controller 12 may instantiate one or more additional virtual service containers 502 and/or service modules 536 to handle the increased traffic. When the network intensive activity concludes, the controller 12 may terminate the additional virtual service containers 502 and/or service modules 536. For example, the proprietor of a managed component may purchase a virtual network function, such as anti-virus or content filtering according to a certain capacity. The proprietor may also purchase additional overflow capacity, which may be implemented on when needed.

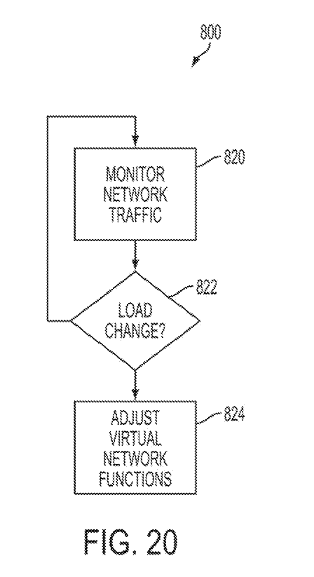

FIG. 20 is a flow chart showing one embodiment of a process flow 820 for actively managing the virtual network function load of a managed component utilizing a virtual service container 502. At 820, network traffic to a particular managed network 18 and/or managed user device 19 may be monitored, for example, by a monitoring virtual network function implemented by a service module 536 of a virtual service container 502. If the traffic load changes at 822, then the controller 12 may, at 824, adjust the virtual network functions provided. For example, if the network traffic to or from a managed component increases, the controller 12 may instantiate additional virtual service containers 502 and/or service modules 536 thereof to handle the increased load. Load changes may be measured and compared over any suitable time period. For example, a load change may be indicated if it persists relative to historical levels for X minutes ago, X hours ago, X days ago, X weeks, ago, etc. Examples of how virtual service containers 502 and/or service modules 536 thereof may be instantiated are provided herein above with respect to FIGS. 16 and 17. If the network traffic decreases, then the controller 12 may terminate one or more virtual service containers 502 and/or service modules 536 thereof so as to conserve system resources. In some embodiments, when a load increase is detected, the controller 12 may notify a sales person or otherwise initiate an offer to the proprietor of the affected network to purchase a web caching network function, a web compression network function, which could reduce network traffic without the need to buy additional network function capacity. A web caching or web compression service, for example, may be implemented by initiating one or more additional virtual service containers 502 and/or service modules 536 thereof.

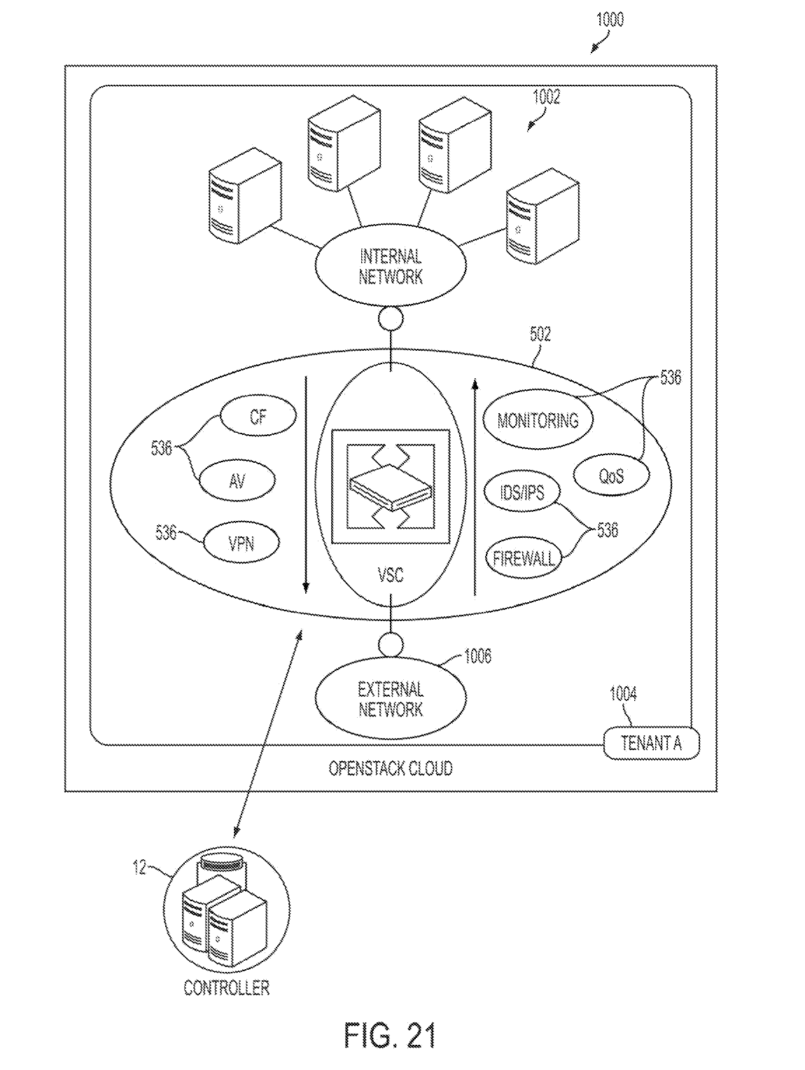

FIG. 21 is a diagram showing one embodiment of an environment 1000 for providing virtual network functions to customers utilizing virtual service containers 502. The environment includes a managed component (e.g., a managed network 1002) and a virtual service container 502 executing service modules 536. The virtual service container 502 may provide virtual network functions that include processing network traffic to and/or from the managed network 1002 and an external network 1006. The external network 1006 may include network locations that are not within the managed network such as, for example, other corporate sites, a network functions management system (FIG. 6), locations accessible via the Internet, etc. The virtual service container 502 may be executed at a service hub or tenant 1004. The service hub 1004 may include any suitable location where a virtual service container 502 may be executed, as described herein above. Although a managed network 1002 is shown in FIG. 21, in some embodiments the virtual service container 502 additionally and/or alternatively provides virtual network functions to other managed components such as, for example, one or more individual managed devices.

In various embodiments, the virtual service container 502 may be logically positioned at a gateway position such that all of the traffic originating behind the virtual service container 502 (e.g., from the managed network 1002) flows through and out of the virtual service container 502 on its way to other environment components, such as the external network 1006 and all traffic directed from the managed network 1002 to the other environment components passes through the virtual service container 502. Alternatively, the virtual service container 502 may be logically positioned at a non-gateway position where some or all traffic of the managed network 1002 is routed to the virtual service container 502. For example, some multi-tenant virtual service containers, described herein, may receive traffic from multiple managed components.

The controller 12 may instantiate the virtual service container 502, provide service modules 536 and configure service modules 536, for example, as described herein. The controller 12 may also monitor the operation of the virtual service container 502. Should an error issue occur, the controller 12 may take a remediating action such as, for example, removing and re-initializing a service module 536 or the virtual service container 505, changing a configuration of a service module 535 or the virtual service container 505, etc. An error issue may include, for example, if the virtual service container 502 or service module 536 becomes unresponsive, slow, overloaded, etc. The controller 12 may be in communication with the virtual service container 505 using any suitable protocol or software package including, for example, OPENSTACK and the OPENSTACK API. For example, the controller 12 may utilize a QUANTUM virtual network to connect with a service hub 1004 and instantiate the virtual service container 505 and associated service modules 536.

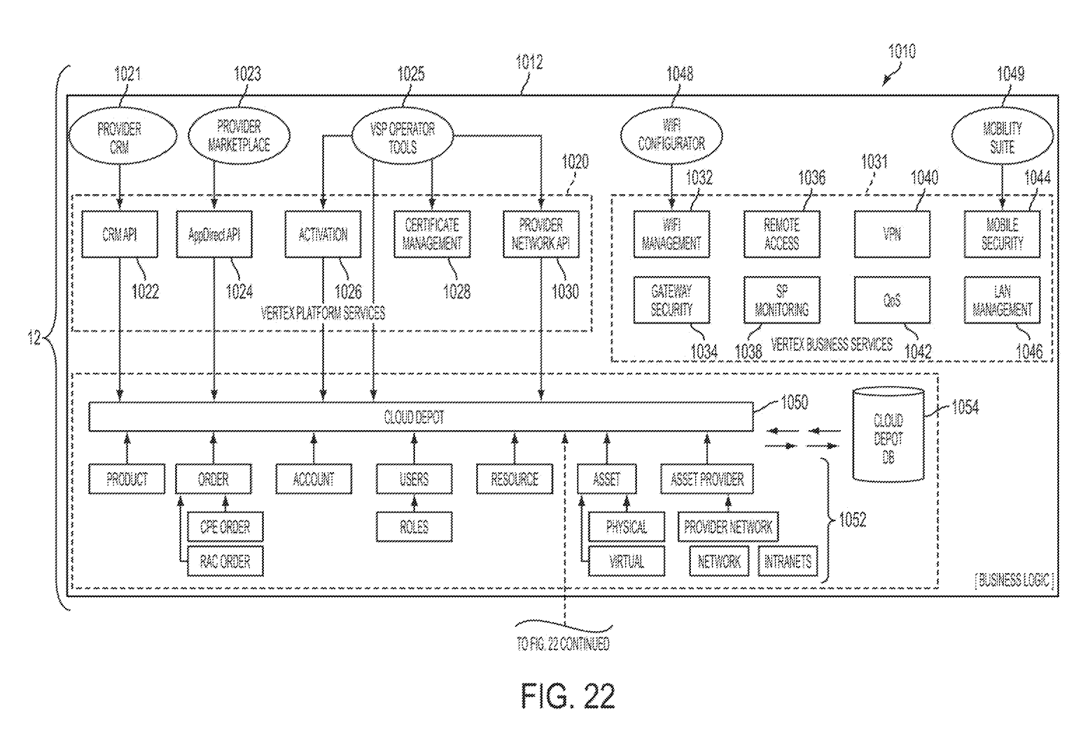

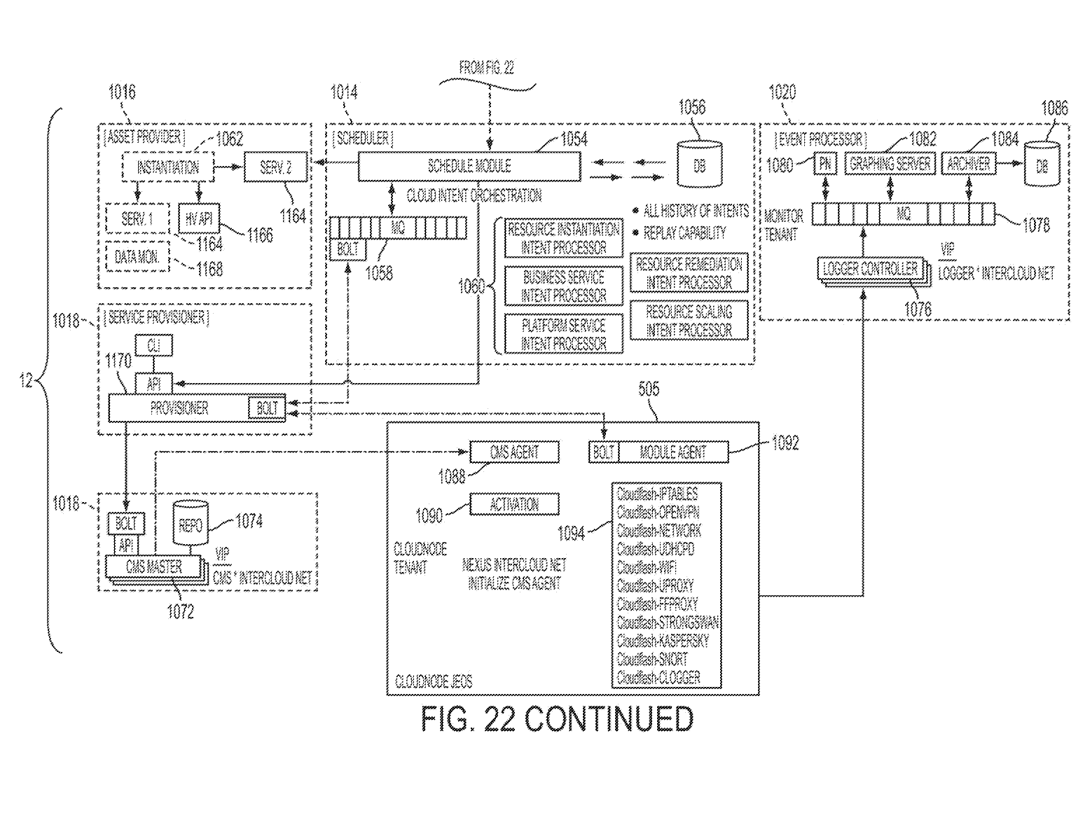

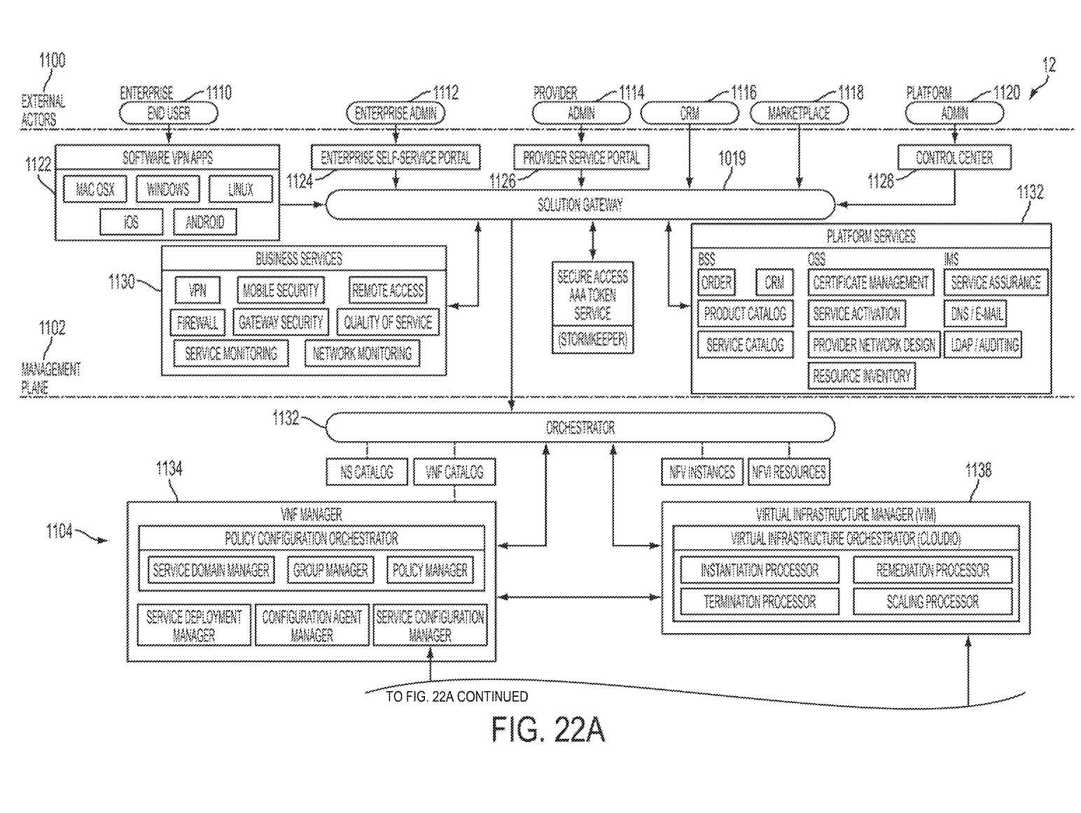

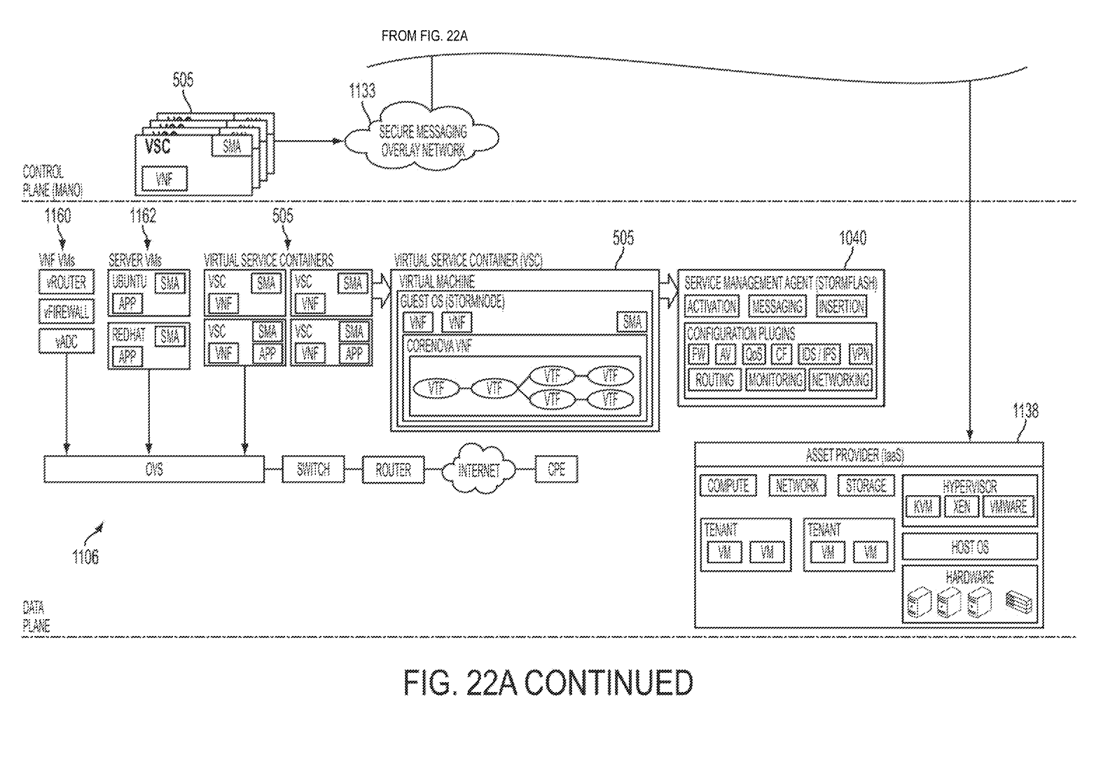

FIG. 22 is a system diagram showing one embodiment of a controller 12 and virtual service container 505 including details of the controller 12. The controller 12 may comprise business logic 1012, a scheduler 1014, an asset provider 1016, a service provisioner 1018, an event processor 1020. As described herein, the controller 12 may be executed at any suitable service hub 402 location or locations including, for example, one or more service hubs 402 at proprietary locations, services such GOOGLE CLOUD, GOOGLE COMPUTE ENGINE, AMAZON WEB SERVICES, AMAZON EC2, etc. The business logic 1012 generally provides high-level access to the controller 12 to various different user types including, for example, administrative users of the network functions management system 500, users associated with managed networks or devices, and/or intermediate service providers. For example, the network functions management system 500 may provide its services to an Internet services provider (ISP) or other telecommunications provider which may be an intermediate service provider. In some embodiments, the business logic 1012 may provide high-level system access to the intermediate service provider as well as customers of the intermediate service provider. The customers of the intermediate service provider, for example, may be users of managed networks or devices.

The business logic 1012 may comprise platform services 1020. Platform services may be provided, for example, to intermediate service providers and/or managed components. A customer resource management (CRM) application program interface (API) 1022 may allow third party CRM systems 1021 with access to the controller 12. For example, the third party may be an intermediate service provider and the CRM API 1022 may allow the intermediate service provider to request actions and provide information about its customer, which may be users of managed networks and/or devices. An App API 2014 may be provided to support an intermediate service provider marketplace 1023 framework. For example, the intermediate service provider may provide its customers with the marketplace 1023 for purchasing network function. The marketplace 1023 may be configured to provide the controller 12 with orders for network functions, which the controller 12 may implement as described herein. An activation module 1026 may be utilized by the controller 12 to activate network functions provided by hardware service providers, such as consumer premises equipment, for example, as described in U.S. Pat. Nos. 8,341,317, 8,078,777 and 7,783,800, which are incorporated herein by reference in their entireties.

A certificate management module 1028 may provide a common format for environment components to utilize certificates, for example, for identification. A Provider network API 1030 may be utilized to allow users to manipulate the Wide Area Network (WAN) and Local Area Network (LAN) connections of various virtual service containers 502. For example, as described herein, LAN connections may be used by the virtual service container 502 to communicate with managed devices and networks. WAN connections may be used to communicate with outside networks, such as 1006. In some embodiments, operator tools 1025 may be in communication with various components of the platform services 102. For example, operator tools 1025 may comprise user interfaces that are accessible to intermediate service providers and/or users of managed components to provide access to network functions, analytics regarding network functions, etc.

Business services 1012 may comprise higher level services provided to intermediate service provider users, IT management system users 500, and/or users of managed components with high-level access to the controller 12. Business services 1012 may allow users to configure virtual network functions provided by virtual service containers 502 to managed networks or devices. For example, a WiFi management module 1032 to manipulate the WiFi related virtual network functions provided by virtual service containers 502. A remote access module 1036 may provide functionality to manipulate remote access to a managed network (for example, by a managed device). Virtual Private Network (VPN) module 1040 may provide functionality to configure VPN-related services provided by virtual service container 502. A mobile security module 1044 may provide functionality for configuring mobile security related services such as filtering services, anti-virus, etc. Gateway security 1034 may provide functionality for modifying network functions related to regulating network traffic such as, for example, filters, firewalls, etc. SP monitoring module 1038 may allow users to modify network functions related, for example, to LAN bandwidth, CPU utilization, managed device health, etc. The QoS module 1042 may allow users to modify network functions related to quality of service (QoS). A LAN management module 1046 may allow users to configure LAN related services such as, for example, network performance monitoring, DHCP server, etc. Some or all of the modules of the business services 1012, in some embodiments, may be accessible via external interfaces such as, for example, the WiFi configurator 1048 or the mobility suite 1049. Some interfaces 1048, 1049 may be optimized to communicate with particular modules. For example, the WiFi Configurator 1048 may be in communication with the WiFi management module 1032. The mobility suite 1049 may be in communication with the mobile security module 1044, etc.

A cloud depo 1050 may represent an abstraction layer that records the existence and/or statuses of various objects utilizing the controller 12, for example, at a cloud depo database 1054. Various different types of objects may be utilized. For example, a product may represent a virtual service container 505 or module(s) 536 thereof for providing a network function. An order may represent an order for a virtual network function and may include an order for a network function provided through any type of IT service provider 14 including a consumer premises equipment device (CPE Order) and an order for a network function provided through a virtual service container 505 (RAC Order). Accounts may describe accounts to various users including intermediate service provider users, IT management system users 500, and/or users of managed components. In some embodiments, user objects may also be described by roles, e.g., intermediate service provider users, IT management system users 500, users of managed components, etc. Resources may describe, for example, hardware resources (e.g., service hubs 402) available to execute the controller 12. Assets may describe locations from which virtual network functions may be executed (e.g., service hubs 402). Asset providers may be providers of assets including, for example, proprietary networks and equipment, commercially accessible cloud networks, etc.

Input received by the controller through the business logic 1012 may be translated into specific actions utilizing the scheduler 1014. For example, the scheduler 1014 may be in communication with the cloud depo 1050 and various other components of the business logic 1012. A scheduling module 1054 may receive communications from the business logic 1012 and execute an appropriate process 1060. Example processes include a resource instantiation process, a business or network function process, a platform service process, a resource remediation process and a resource scaling process. The resource instantiation process may be utilized to instantiate a virtual service container 505, as described herein. The business service process may be used to create and/or manipulate a virtual service container 505 or service module 536 thereof. The platform service process may be used to implement various services across an entire managed network. The resource remediation process may be used to intervene when a virtual service container 505 is not operating correctly. The resource scaling process may be used to change the scale of an existing implemented network function.

In various embodiments, the scheduler 1014 may utilize a message queue. The message queue may receive messages from the business logic 1012 and/or other components of the controller 12 such as the event processor 1020, the asset provider 1016, the service processor 1018, etc. The scheduler 1014 may also direct messages to other components utilizing the message queue. Any suitable message management queue software may be used including, for example, IBM MQ. For example, the scheduler may deposit a requested action or process on the message queue 1058. The message queue 1058 may subsequently deliver the action or process to the appropriate controller component.

The asset provider 1018 may handle low-level requests to instantiate virtual service container 505. For example, the scheduler 1014 may direct requests to the asset provider 1018 to instantiate a virtual service container 505. An instantiation module 1062 may be configured to execute specific actions to instantiate virtual service containers 505 in different service hub environments. The instantiation module 1062 may be implemented utilizing any custom and/or customer software. For example, in some embodiments, the instantiation module 1062 maybe implemented using the HEAT SERVICE MANAGEMENT package available from FRONTRANGE SOLUTIONS, INC. The instantiation module 1062 may comprise various modules for instantiating virtual service containers 505 on different types of service hubs. For example, a hypervisor or HV API module 1166 may be utilized to allow the asset provider 1062 to request appropriate commands to instantiate virtual service container 505 across different virtual machine technologies including, for example, different hypervisors with different command sets and communication protocols. The HV API module 1166 may be configured according to any suitable API or API, depending on the service hubs 402 used. For example, the HV API module 1166 may utilize OPENSTACK. Service API's 1164 may enable the asset provider 1062 to communication with and request virtual service containers 505 on various commercially available cloud computing services such as, for example, GOOGLE CLOUD, GOOGLE COMPUTE ENGINE, AMAZON WEB SERVICES, AMAZON EC2. A data monitoring module 1168 may collect data describing communications between the Cloud Foundry 1162 and the various service hubs.

A service provisioner 1018 may be configured to upload modules 536 and module configurations to virtual service containers 505, as described herein. A provisioner 1170 may receive instructions from the scheduler 1014 and/or a command line interface (CLI) via the illustrated application program interface (API). The provisioner 1170 may translate high level requests into one or more low-level commands. For example, the scheduler 1014 may request that the service provisioner 1018 instantiate and/or reconfigure a service module 536 at a virtual service container 505. The provisioner 1170 may translate the requested action into the low level commands to the hypervisor managing the affected virtual service container 505 for making the requested changes. A configuration management master or CMS master 1072 may manage the configuration of various virtual service container 505. For example, the CMS master 1072 may track virtual service containers 505 executing at various service hubs and their status or configuration. The configuration data may be stored at a database 1074.

The event processor 1020 may receive event data from various virtual service containers 505 executing at various service hubs. A logger controller 1076 may receive the status or event messages from the various virtual service containers 505. The event processor 1020 may utilize a message queue 1078 to process received events, such as the IBM MQ described above. A proactive notification or PN module 1080 may be configured by various users through the business logic 1012 to provide notice to users upon the occurrence of specified events. For example, users may be permitted to specify metrics and thresholds. When a metric meets a determined threshold, the user may be notified. Metrics may describe virtual service containers 505, service modules 536 and/or descriptions of virtual network functions. A graphing module 1082 may provide users with graphical interfaces describing the received events, for example, similar to the global status maps and site views module 162 described herein. An archiver 1084 may store received events at a database 1086.

The virtual service container 505 shown in FIG. 22 comprises a configuration management master agent 1088 that may be in communication with the CMS master 1072 to receive and report configuration information. An activation agent 1090 may manage the initial activation of the virtual service container 505, for example, as described herein above with respect to FIG. 15. A module agent 1092 may be in communication with the provisioner 1170 to manage service modules 536, indicated at service module list 1094.

FIG. 22A is a system diagram showing another embodiment of a controller 12. Various different types of users may access the controller 12 via the management plane 1102 including, for example, intermediate service provider users, IT management system users 500, and/or users of managed components. The management plane 1102 may operate in a manner similar to that described above with respect to the business logic 1012. Enterprise users may be users associated with a managed component, such as a managed network or device. In some embodiments, the management plane 1102 supports different levels of enterprise users including, for example, enterprise end users 1110 and enterprise administrative users 1112. An enterprise user 1110 may access a managed network through the controller 12 via one or more secure connection or VPN apps. For example, the VPN app may put the user 1110 in communication with a virtual service container 505 at a gateway position in the managed network that the user 1110 requests to access. Different operating systems may utilize different VPN apps. Enterprise administrative users 112 may utilize an enterprise self service portal 1124 to manage network functions provided to their associated managed network or device.

Provider users and modules 1114, 1116, 1118 may be associated with an intermediate service provider. Provider administrative users 1114 may utilize a provider service portal 1126, for example, to configure network functions available to enterprise users who access the controller 12 through the intermediate service provider. A CRM system 1116 may provide commands and receive data into a customer relationship manager (CRM) associated with the intermediate service provider. Marketplace module 1118 may be similar to the marketplace 1023 described herein above. Platform administrative users 1120 may be associated with the party implementing the network functions management system 500 and may access the system via a control center 1128.

The various users may access a solution gateway 1019, which may direct communications to and from the users to a business services module 1130 and a platform services module 1132. The business services module 1130 may operate in a manner similar to the business services module 1031 described herein above. The module 1130 shown in FIG. 22A, however, includes additional modules that may be executed with either business services module 1031, 1130 including, for example, a firewall for configuring firewall services and a network monitoring module for configuring monitoring and logging services. Platform services module 1132 may also operate in a manner similar to the platform services module 1020 described above.

Commands and messages to and from the management plane 1102 may be managed by a control plane 1104. The control plane 1104 may translate the commands and messages from the data plane 1106 comprising virtual service containers and the management plan 1102. The control plane 1104 may comprise an orchestrator 1132 for receiving and translating messages and commands. The orchestrator 1132 may be in communication with a virtual infrastructure management 1136. The virtual infrastructure (VIM) manager 1136 may operate in a manner similar to that described above with respect to the scheduler 1014. For example, the VIM manager 1136 may comprise various processes such as an instantiation process for instantiating virtual service containers 505, a termination process for terminating virtual service containers 505, a remediation process for processing anomalies in virtual service containers 505 or service modules 536 thereof, and a scaling process for instantiating and/or terminating virtual service containers 505 and service modules 536 thereof in response to changes in network traffic, as described herein. The VIM manager 1136 may direct commands directly to an asset provider 1138 executing a virtual service container 505 and/or to the virtual network function VNF manager 1134.

The VNF manager 1134 may comprise functionality for configuring virtual service containers 505 and service modules 536 thereof, for example, as described herein above with respect to the service provisioner 1018. In some embodiments, the VNF manager 1134 may be in communication with the virtual service containers 505 utilizing a secure connection 1133. The VNF manager may comprise a Policy Configuration Orchestrator that may monitor network functions (e.g., service modules 536) registered for each virtual service container 502 and orchestrate the construction of an appropriate configuration for the virtual service container 502 including, for example, modules 536 to execute and configurations for the selected modules 536. For example, the Policy Configuration Orchestrator may receive from the Orchestrator 1132 services requested by the appropriate user, any user settings for the requested services, any policies for the requested services, etc. A Service Deployment Manager may determine the low-level actions that are necessary to configure a particular virtual service container 502. A Service Configuration Manager and Configuration Agent Manager may communicate with target virtual service containers 502 to configure the devices 502.

Referring to the data plane 1106, the asset provider 1138 provides functionality for communicating with various service hubs for executing virtual service containers 505. For example, the asset provider may comprise one or more API's, such as OPENSTACK, AMAZON WEB SERVICES API or GOOGLE COMPUTE ENGINE API for communicating with service hubs using the respective API's. The asset provider 1138 may also comprise API's for communicating with various different hypervisors, host operating systems and hardware types.

Referring to the data plane, VNF refers to virtual network functions 1160. For example, FIG. 22A shows three virtual network functions or VNF's, a router service, a firewall service and an Application Delivery Controller (ADC) service. Each VNF 1160 may be executed by a virtual machine (e.g., a virtual service container) executed at service hubs 1162. For example, FIG. 22A shows an example service hub 1162 executing the UBUNTU operating system and an example service hub 1162 executing a REDHAT Linux operating system. It will be appreciated that any suitable type of service hub 1162 utilizing any suitable operating system may be used. Virtual service containers 505, as shown execute VNF's and may comprise an app (e.g., module 536) and a Service Management Agent (SMA), e.g., module configuration 536. Each virtual service container 505 may execute a guest operating system or guest OS. The guest OS may be a JeOS, as described herein. Below the guest OS, the virtual service containers 505 may comprise virtual network functions (VNF's). Each VNF, for example, may represent a service module 536 for providing a virtual network function. A service management agent (SMA) 1040 may be executed at the virtual service container 505. The SMA 1040 may comprise configurations for one or more of VNF's implemented by the service modules 536.

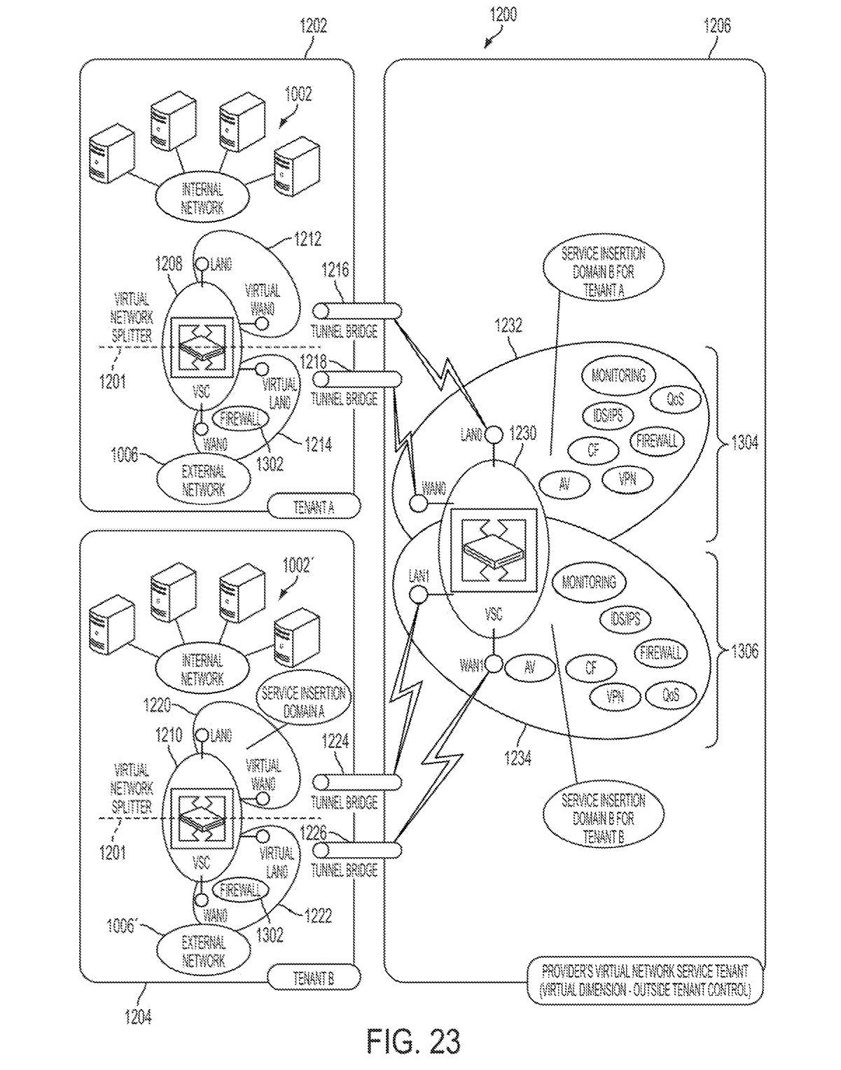

In some embodiments, as described herein, traffic from a managed network 1002 or device may be processed at multiple locations either sequentially or simultaneously. For example, FIG. 23 is a diagram of an environment 1200 that shows multi-tenancy in a virtual service container such that a single virtual service container 1230 is able to deliver multiple services of the same type via a separate interface created by a virtual network splitter 1201. A first service hub 1202 may execute a first virtual service container 1208 servicing a first managed network 1002 (or device). The virtual service container 1208 may comprise a LAN connection 1212 that interfaces network traffic to the managed network 1002 and a WAN connection 1214 that interfaces network traffic to the external network 1006.

In some embodiments, the virtual service container 1208 implements some virtual network functions itself, for example, utilizing one or more service modules 1302 (e.g., service modules 536 described herein above). Additional virtual network functions may be provided to the managed network 1002 utilizing the second virtual service container 1230 implemented at a different tenant or service hub 1206. For example, the virtual service container 1208 may execute a virtual network splitter 1201. The virtual network splitter 1201 may determine a portion of network traffic to and from the managed network 1002 that is to be transmitted to the virtual service container 1230 for the application of additional virtual network functions. The splitter 1201 may determine how to split the network traffic according to any suitable criteria including, for example, the time of day, the network load, the type of traffic, a heuristic describing the traffic. Traffic selected by the splitter 1201 may be directed to the second virtual service container 1230 via a secure connection 1216, such as a VPN connection. The virtual service container 1230 may perform various other virtual network functions for the selected traffic, for example, utilizing service modules 1304. Processed traffic, in some embodiments, is returned to the first virtual service container 1208 via secure connection 1218. Returned traffic from the virtual service container 1230 may be passed to the managed network 1002 and/or the external network 1006 as indicated.

A third virtual service container 1210 executed at a different service hub 1204 may also utilize the virtual network functions provided by the second virtual service container 1230. For example, the second virtual service container 1230 may service traffic from the first virtual service container 1208 and the third virtual service container 1210 simultaneously. The third virtual service container 1210 may service a managed network 1002′ or device in communication with an external network 1006′, for example, as described herein. The second virtual service container 1210 may comprise a LAN connection 1220 and a WAN connection 1222 and may execute a virtual network splitter 1201, for example, as described herein above with respect to the first virtual service container 1208. The virtual service container 1210 may be in communication with the virtual service container 1230 via secure connections 1224, 1226.

Multi-tenancy can be used to facilitate various different system configurations. For example, in some embodiments, the second virtual service container 1230 may be optimized to perform a certain virtual network function. For example, the second virtual service container 1230 may be implemented at a service hub 1206 with additional and/or different processing capacity allowing the second virtual service container 1230 to perform more resource-intensive virtual network functions such as, for example, anti-virus, intrusion prevention, etc. For example, the virtual network splitters 1201 may direct to the second virtual service container 1230 network traffic that requires the specific type of virtual network function performed by the second virtual service container 1230. Also, in some embodiments, multi-tenancy is used to facilitate peak traffic for the managed networks 1002, 1002′. For example, the second virtual service container 1230 may provide the same virtual network functions provided by the first and/or third virtual service container 1208, 1210. When traffic volume at one of the virtual service containers 1208, 1210 exceeds a threshold level, the virtual network splitter 1201 at that virtual service container 1208, 1210 may begin to transfer traffic over the threshold to the second virtual service container 1230.

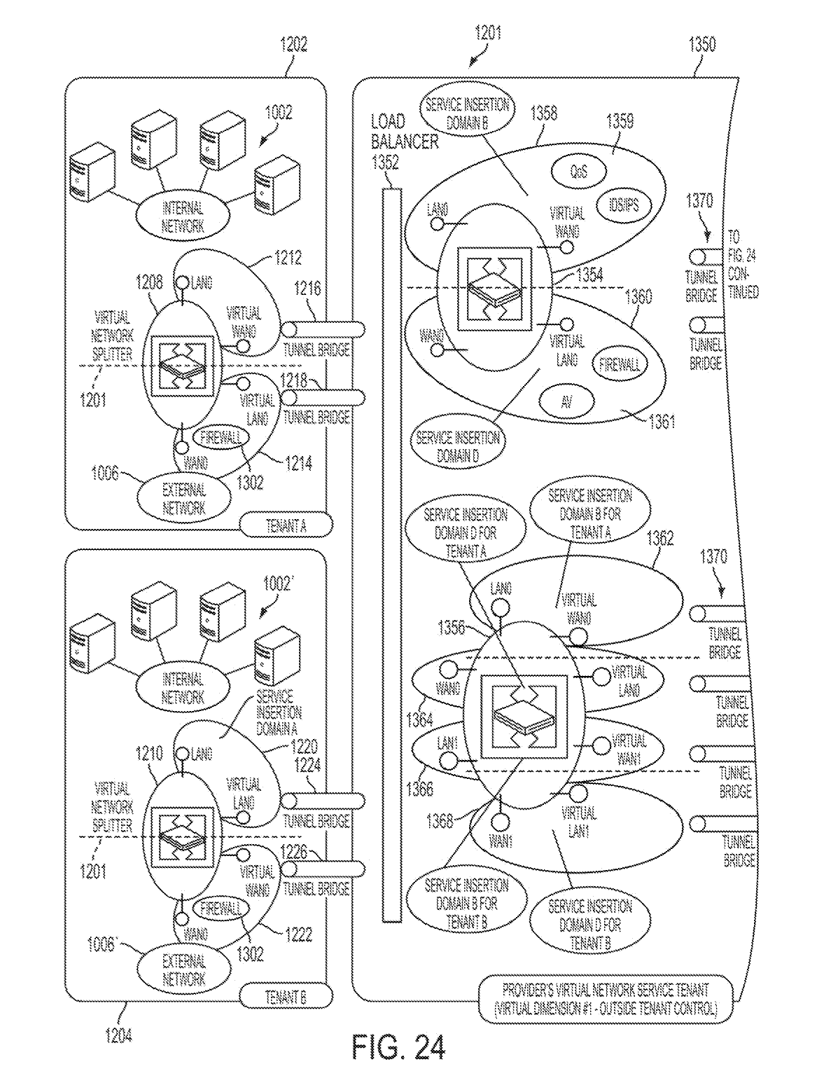

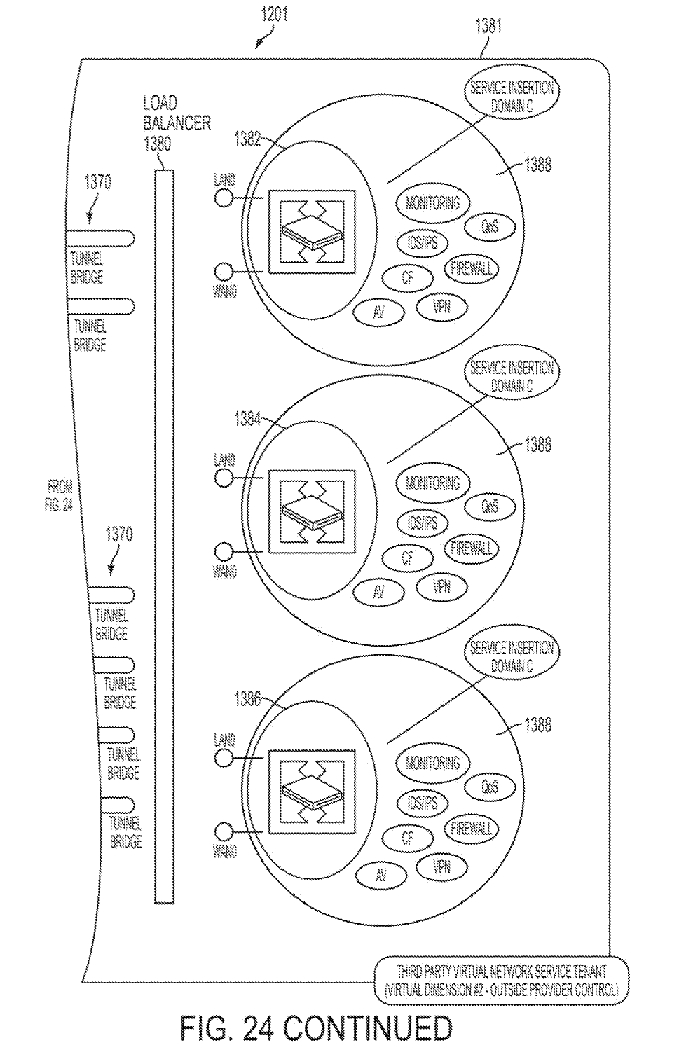

FIG. 24 is a diagram of an environment 1201 utilizing additional layers of multi-tenancy. The service hubs 1202, 1204 and virtual service containers 1208, 1210 may direct a portion of the network traffic (e.g., as determined by splitters 1201) to an additional service hub 1350, which may implement virtual service containers 1354, 1356. In some embodiments, the service hub 1350 also implements a load balancer 1352. The load balancer 1352 may receive incoming traffic and direct it to the virtual service container 1354, 1356 that is configured to and/or has capacity to perform the requested virtual network function or services. In the example embodiment, the virtual service container 1354 comprises two ports, a LAN port 1358 and a WAN port 1360. The virtual service container 1354 may execute various service modules 1359, 1361 for performing virtual network functions. The virtual service container 1356 may comprise ports 1362, 1364, 1366 and 1368 and may execute various service modules for performing virtual network functions. In some embodiments, the virtual service containers 1354, 1356 may be executed at a service hub 1350 that is associated with a provider of the network functions management system 500.

One or both of the service modules 1354, 1356 may direct some or all of their received network traffic to an additional service hub 1381 comprising additional virtual service containers 1382, 1384, 1386 via secure connections 1370. A load balancer 1380 may direct traffic received at the service hub 1381 to one of the respective virtual service containers 1382, 1384, 1386. Each of the virtual service containers 1382, 1384, 1386 may execute service modules 1388 for implementing virtual network functions.

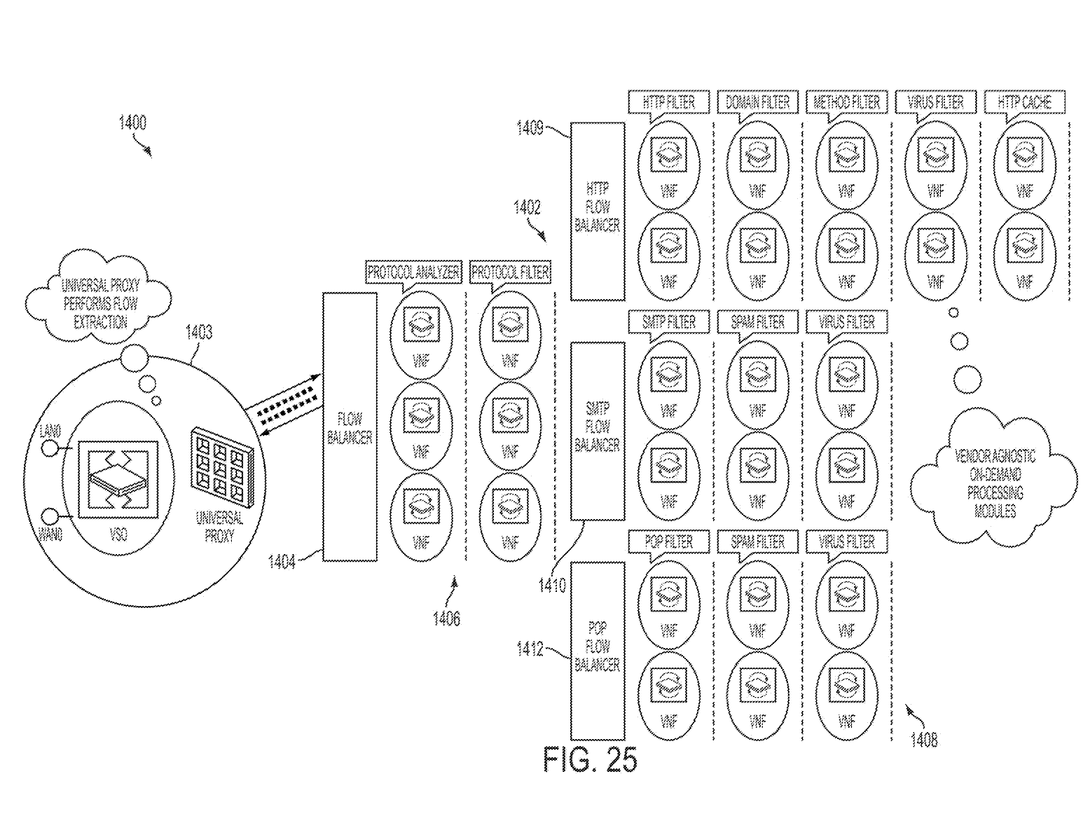

FIG. 25 is a diagram of a service hub 1400 illustrating layered service modules for providing virtual network functions. For example, the service hub 1400 may execute various service modules 1402 for implementing virtual network functions. The service hub 1400 may execute a virtual service container 1403 which may, in turn, execute the various service modules 1402 and flow balancers 1404, 1409, 1410, 1412. Network traffic received by the virtual service container 1403 may be provided to flow balancer 1404. Flow balancer 1404 may distribute the received traffic to service modules at a first level 1406 for provision of virtual network functions. Some or all of the traffic directed to the first level service modules 1406 may be provided to the one or more load balancers 1409, 1410, 1412 for provision to second level service modules 1409. For example, an HTTP load balancer 1409 may direct portions of the traffic to second level service modules performing HTTP-related virtual network functions. An SMTP flow balancer 1410 may direct portions of the traffic to second level service modules performing SMTP related services. A POP flow balancer 1412 may direct portions of the traffic to second level service modules performing POP related virtual network functions.

In various embodiments, the virtual service containers described herein may be utilized to connect networks 18 to otherwise incompatible networks such as, for example, Multiprotocol Label Switching Networks (MPLN). For example, a service provider 14 comprising one or more virtual service containers 502 may connect to the MPLN or other similar network, allowing the MPLN or similar network to communicate with the Internet 16. Any type of external network structure or grouping can be brought into the virtual service container. Once within the virtual service container the traffic it carries can be cross-linked with other external networks and it can also receive the same services (security, network) as any other traffic that exists within the virtual service container.

In some embodiments virtual service containers 502 may be utilized to implement different levels of service within a single network 18. For example, a network 18 may provide a more lax level of network functions to devices that are configured to have significant levels of outside network traffic, such as e-mail servers 408, web servers 410, and other similar servers. (FIG. 4). For example, traffic from select network components, such as these, may be routed through a different set of virtual service containers 502 and/or different service modules 536 that provide a different level of service relative to other network components.

In some embodiments, embodiment a cloud controller is integrated with a 3^{rd} party controller via an API such that the cloud controller can provision a virtual service container into a tenant network and that virtual service container instance can then be personalized with service modules during initial configuration and throughout the service lifecycle as a result of a secure connection back to the controller whereby service events are propagated to the controller from the Virtual service container in real time.

In some embodiments, multi tenancy is created in the virtual service container whereby any virtual service container created has multi-tenancy and load balancing capability created by a virtual network splitter which through a secure communication path connection creates new virtual interfaces on Virtual service container.

In some embodiments, a service hub or tenant service insertion can occur at multi-levels of domains such that services can be distributed across both providers and multiple third party networks.

In some embodiments, an inline universal proxy engine performs dynamic protocol analysis, session flow extraction and service chaining by recognizing and executing on discrete atomic data transformation with which business rules can be applied to enabling dynamic configuration and virtual network functions insertion during runtime.

Various embodiments are directed to a Network Functions Virtualization (NFV) and Software Defined Networking (SDN) that may be enabled by utilizing three technologies and techniques in conjunction to create a novel and flexible platform. These technologies are: minimalistic base operating system software, Flexible API for attachment of network functionality, as described herein with respect to FIG. 8, and secure activation as described herein with respect to FIG. 15.

The NFV/SDN solution may be a fully virtualized platform where all network data- and control-plane operations take place within a virtualized operating instance (e.g., a virtual service container 502). This virtualized instance runs a minimalistic operating system, commonly called Just Enough Operating System (JeOS), that provides only sufficient functionality to contact the controlling software node and initiate steps to cause additional functionality to be incorporated into the calling node. By utilizing a JeOS environment the overall complexity of the system may be reduced and the performance & scalability characteristics of the overall virtualized system may be increased. A simpler environment may have fewer failure modes, may have fewer layers of software to slow processing and by virtue of having fewer components it further takes up fewer physical compute resources (RAM, CPU, disk). The JeOS may comprise: a Linux or other OS kernel, a TCP/IP networking stack, an API handler, and a Module incorporation foundation (SaltStack).

A second feature of the solution is a flexible and comprehensive API that enables the loading, activation and unloading of appropriately structured code service modules 536 into the JeOS environment. These service modules 536 may control the overall behavior of the virtual container 502 including, for example, Network routing capabilities, Packet inspection capabilities, Packet manipulation capabilities, Anti-virus, Content filtering, Intrusion detection, Digital loss prevention, etc. By modularizing each component of functionality they can be incorporated into the overall functionality of the instance simply and rapidly; in addition, each instance can have similar or unique sets of service modules to perform a common set of processing across all packets or specific processing for only particular types of network packets.

An additional feature of the solution is the secure activation and control modules. This secure management sub-system allows the virtualized instance to communicate with the controlling node such that all data packets arrive with guaranteed integrity; they cannot be reasonably decoded should they be intercepted. This is utilized by the controller 12 to ensure that only authorized devices receive downloaded applications and that any transmitted metrics information sent by the virtual service container 502 is unaltered when received by the controlling node.

The virtual service container 502, is a security and network appliance providing largely the same level of functionality and services as does the physical appliance treated by U.S. Pat. Nos. 8,341,317, 8,078,777 and 7,783,800, which are incorporated herein by reference in their entireties above. Since the virtual service container 502 is virtual it may open up additional features not possible with the physical appliance. The lifecycle of the virtual service container 502 is described herein. Since a virtual service container 502 is implemented at a service hub 402 using software rather than at a physical location within a managed network, several new steps may take place to start the activation sequence. A customer may order a product that requires a virtual service container 502. The controller 12 may process the order and instantiate the virtual service container 502 within a service hub 402. The virtual service container 502 may be created from a software image, it may be allocated virtualized RAM and CPU resources and a public IP address.

Once all the above is allocated/created, the virtual service container 502 begins to execute and follows a similar activation process to its physical counterparts, as described herein and in the patents incorporated by reference herein above. For example, the virtual service container 502 may request activation information from the controller 12; send an activation key; and receive configuration settings that direct the virtual service container 502 to provide subscribed or purchased services, such as: QoS; Content filtering; Anti-virus; Monitoring; etc.

In some embodiments where the virtual service container 502 is not at the gateway position for a managed network it may not be able to provide services such as DHCP, DSL termination, switch, DMZ, etc. However, because it is virtual and it is entirely under software control we can provide new features not possible with a physical device. For example, virtual service container 502 may be capable of dynamically and effectively instantaneously altering the size and capacity of the VCG to handle varying user traffic. This is useful when traffic spikes, for example, due to end-of-the-month accounting must be done or when a large sales team, for instance, is visiting a headquarters for a conference. The virtual and dynamic nature of the virtual service container 502 enables novel network architectures to be constructed on-the-fly.

As an example, a large service provider can allocate a set number of nodes to handle traffic during normal usage periods. As traffic passes through the system business logic may identify unusual data being transmitted and so a new virtual service container 502 can be instantiated and inserted into the traffic data path to perform a deeper analysis. Should that analysis prove nefarious activity then that activity can be further analyzed, modified or blocked. Another example would be web filtering and web caching. This type of functionality can be incorporated into a live network without requiring any physical rewiring or downtime of the network; similarly, these features may be removed without traffic or service disruption. In all of these examples, traffic data processing utilizes commodity compute nodes that can be used for a variety of network-related tasks. Additional processing executes only for the duration that it is needed before the resources being consumed are released back into the overall pool.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Reference in the specification to “one embodiment,” to “an embodiment” or to “various embodiments” means that a particular feature, structure, or characteristic described in connection with the embodiments is included hi at least one embodiment of the invention. The appearances of the phrase “in one embodiment” or “in various embodiments” in various places in the specification are not necessarily all referring to the same embodiment. Reference to embodiments is intended to disclose examples, rather than limit the claimed invention. While the invention has been particularly shown and described with reference to several example embodiments, it will be understood by persons skilled in the relevant art that various changes in form and details can be made therein without departing from the spirit and scope of the invention.

It should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

It is to be understood that the figures and descriptions of embodiments of the present invention have been simplified to illustrate elements that are relevant for a clear understanding of the present invention, while eliminating, for purposes of clarity, other elements, such as, for example, details of system architecture. Those of ordinary skill in the art will recognize that these and other elements may be desirable for practice of various aspects of the present embodiments. However, because such elements are well known in the art, and because they do not facilitate a better understanding of the present invention, a discussion of such elements is not provided herein.

It should be appreciated that figures presented herein are intended for illustrative purposes and are not intended as design drawings. Omitted details and modifications or alternative embodiments are within the purview of persons of ordinary skill in the art. Furthermore, whereas particular embodiments of the invention have been described herein for the purpose of illustrating the invention and not for the purpose of limiting the same, it will be appreciated by those of ordinary skill in the art that numerous variations of the details, materials and arrangement of parts/elements/steps/functions may be made within the principle and scope of the invention without departing from the invention as described in the appended claims.

It can be appreciated that, in some embodiments of the present methods and systems disclosed herein, a single component can be replaced by multiple components, and multiple components replaced by a single component, to perform a given function or functions. Except where such substitution would not be operative to practice the present methods and systems, such substitution is within the scope of the present invention. Examples presented herein, including operational examples, are intended to illustrate potential implementations of the present method and system embodiments. It can be appreciated that such examples are intended primarily for purposes of illustration. No particular aspect or aspects of the example method, product, computer-readable media, and/or system embodiments described herein are intended to limit the scope of the present invention.

It will be appreciated that the service hubs 402, various servers 408, 410, 412, user devices 19, printer 414, and various other network and other computer components described herein may be any suitable type of computing device including, for example, desktop computers, laptop computers, mobile phones, palm top computers, personal digital assistants (PDA's), etc. As used herein, a “computer,” “computer system,” “computer device,” or “computing device,” may be, for example and without limitation, either alone or in combination, a personal computer (PC), server-based computer, main frame, server, microcomputer, minicomputer, laptop, personal data assistant (PDA), cellular phone, pager, processor, including wireless and/or wireline varieties thereof, and/or any other computerized device capable of configuration for processing data for standalone application and/or over a networked medium or media. Computers and computer systems disclosed herein may include operatively associated memory for storing certain software applications used in obtaining, processing, storing and/or communicating data. It can be appreciated that such memory can be internal, external, remote or local with respect to its operatively associated computer or computer system. Memory may also include any means for storing software or other instructions including, for example and without limitation, a hard disk, an optical disk, floppy disk, ROM (read only memory), RAM (random access memory), PROM (programmable ROM), EEPROM (extended erasable PROM), and/or other like computer-readable media.

Some portions of the above disclosure are presented in terms of methods and symbolic representations of operations on data bits within a computer memory. These descriptions and representations are the means used by those skilled in the art to most effectively convey the substance of their work to others skilled in the art. A method is here, and generally, conceived to be a sequence of actions (instructions) leading to a desired result. The actions are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of actions requiring physical manipulations of physical quantities as service modules or code devices, without loss of generality.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMS), EPROMs, EEPROMs, magnetic or optical cards, application specific integrated circuits (ASICs), or any type of media suitable for storing electronic instructions, and each coupled to a computer system bus. Furthermore, the computers and computer systems referred to in the specification may include a single processor or may be architectures employing multiple processor designs for increased computing capability.

The methods and displays presented herein, unless indicated otherwise, are not inherently related to any particular computer or other apparatus. Various general-purpose systems may also be used with programs in accordance with the teachings herein, or it may prove convenient to construct more specialized apparatus to perform the disclosed method actions. The structure for a variety of these systems will appear from the above description. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

The term “computer-readable medium” as used herein may include, for example, magnetic and optical memory devices such as diskettes, compact discs of both read-only and writeable varieties, optical disk drives, and hard disk drives. A computer-readable medium may also include non-transitory memory storage that can be physical or virtual.

1. An information technology (IT) services management system, the system comprising:
at least one processor and operatively associated memory, wherein the memory comprises instructions that, when executed by the at least one processor, cause the at least one processor to:
execute a controller, wherein the controller is programmed to communicate with at least one virtual service container, wherein the controller is further programmed to instantiate a virtual service container at a service hub, wherein instantiating the virtual service container comprises:
sending to a service hub an instruction to instantiate a virtual service container;
receiving an indication of a secure connection between the controller and the virtual service container;
receiving a message from the virtual service container indicating that the virtual service container is ready to receive a configuration;
verifying an identity of the virtual service container; and
providing the virtual service container with a virtual service container configuration, wherein the virtual service container configuration indicates at least one virtual network function to be provided to a managed component by the virtual service container.

2. The network functions management system of claim 1, wherein the virtual service container configuration indicates a service module for executing the at least one virtual network function, and wherein the controller is further programmed to:
receive from the virtual service container a request to download the service module;
receive from the virtual service container a configuration request for the service module from the virtual service container; and
send to the virtual service container a configuration for the service module, wherein the configuration for the service module describes the at least one virtual network function to be provided to the managed component by the virtual service container.

3. The network functions management system of claim 2, wherein the controller is further programmed to, before sending the configuration for the service module, verify the identity of the virtual service container.

4. The network functions management system of claim 1, wherein the controller is further programmed to:
determine a change to be made to the virtual service container configuration; and
send a new virtual service container configuration to the virtual service container.

5. The network functions management system of claim 4, wherein determining the change to be made to the virtual service container configuration comprises detecting a change in traffic at the virtual service container.

6. The network functions management system of claim 4, wherein determining the change to be made to the virtual service container configuration comprises detecting a change in a geographic location of at least a portion of the managed component.

7. The network functions management system of claim 4, wherein the new virtual service container configuration comprises an indication to the virtual service container to execute an additional service module for executing at least a second virtual network function.

8. The network functions management system of claim 4, wherein the new virtual service container configuration comprises an indication to the virtual service container to terminate the service module.

9. The network functions management system of claim 4, wherein the new virtual service container configuration comprises an indication to the virtual service container to obtain a new configuration for the service module.

10. The network functions management system of claim 1, wherein the controller is further programmed to:
monitor network traffic associated with the at least one managed component;
determine a change in the network traffic; and
analyze the change in network traffic.

11. The network functions management system of claim 10, wherein the change in network traffic is an increase in network traffic, and wherein the controller is further programmed to send a prompt to instantiate a second virtual service container to handle the increase in network traffic.

12. The network functions management system of claim 11, wherein the change in network traffic is an increase in network traffic above a threshold value compared to a historical value of network traffic.

13. The network functions management system of claim 11 wherein the controller is further programmed to, in response to the change in network traffic, send a sales prompt describing additional virtual network functions for the managed component.

14. The network functions management system of claim 10, wherein the change in network traffic indicates a security breach, and wherein the controller is further programmed to request an investigation of the security breach.

15. An network functions management system comprising at least one processor and operatively associated memory, wherein the memory comprises instructions that, when executed by the at least one processor, cause the at least one processor to execute:
a virtual service container, wherein the virtual service container is programmed to execute a first service module for providing a first virtual network function, wherein the virtual service container is programmed to:
receive from a second virtual service container a first portion of network traffic;
apply the first virtual network function to the first portion of network traffic;
after applying the first virtual network function to the first portion of network traffic, send the first portion of network traffic to the second virtual service container;
receive from a third virtual service container a second portion of network traffic;
apply the first virtual network function to the second portion of network traffic; and
after applying the first virtual network function to the second portion of network traffic, send the second portion of network traffic to the third virtual service container.

16. The network functions management system of claim 15, wherein the second virtual service container is executed at a service hub distinct from the at least one processor and wherein the third virtual service container is executed at a second service hub distinct from the service hub and the at least one processor.

17. The network functions management system of claim 16, wherein the at least one processor is further programmed to execute:
a fourth virtual service container; and
a load balancer, wherein the load balancer is programmed to distribute network traffic comprising the first and second portion of network traffic to the virtual service container and additional network traffic to the fourth virtual service container.

18. The network functions management system of claim 17, further comprising a third service hub executing a second load balancer and at least one additional virtual service container, wherein the virtual service container is further programmed to direct at least a portion of the first portion of network traffic and the second portion of network traffic to the at least one additional virtual service container.

19. An network functions management system comprising at least one processor and operatively associated memory, wherein the memory comprises instructions that, when executed by the at least one processor, cause the at least one processor to execute:
a virtual service container wherein the virtual service container is programmed to:
receive a traffic flow from a managed component;
execute a first service module for providing a first virtual network function to the traffic flow;
receive from a controller an instruction to implement a second virtual network function;
while the first service module is executing, download a second service module for providing the second virtual network function to the traffic flow; and
execute the second service module.

20. The network functions management system of claim 19, wherein the virtual service container is also programmed to execute a flow balancer for distributing a first portion of the traffic flow to the first service module and a second portion of the traffic flow to the second service module.
